(19) United States
(12) Patent Application Publication
(10) Pub. No.: US 2026/0180184 A1
(43) Pub. Date: Jun. 25, 2026

(54) ANTENNA

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventors: Masaatsu KAMBAYASHI, Osaka-shi, Osaka (JP); Takanori FUKUNAGA, Osaka-shi, Osaka (JP); Yutaro MIKI, Osaka-shi, Osaka (JP); Suguru YAMAGISHI, Osaka-shi, Osaka (JP); Ichiro KUWAYAMA, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 19/121,178

(22) PCT Filed: Jun. 29, 2023
(86) PCT No.: PCT/JP2023/024158

§ 371 Date: Apr. 15, 2025

(30) Foreign Application Priority Data
Oct. 17, 2022 (JP) 2022-166185

(51) Int. Cl. H01Q 9/04; H01Q 1/24; H01Q 1/38

(52) U.S. Cl. CPC H01Q 9/0421; H01Q 1/243; H01Q 1/38

(57) ABSTRACT

An antenna includes: a dielectric substrate; a feed conductor portion provided on the dielectric substrate; a first conductor portion that is provided on a substrate surface of the dielectric substrate, is connected to the feed conductor portion, and is linear or belt-like with one end as an open end; and a second conductor portion that is linear or belt-like and includes a first end portion and a second end portion on an opposite side to the first end portion. The first end portion is connected to an intermediate portion between both ends of the first conductor portion, the second end portion is an open end, and the second conductor portion protrudes from the intermediate portion.

### CROSS-REFERENCE TO RELATED APPLICATIONS

This application is the U.S. national stage of PCT/JP2023/024158 filed on Jun. 29, 2023, which claims priority of Japanese Patent Application No. JP 2022-166185 filed on Oct. 17, 2022, the contents of which are incorporated herein.

### TECHNICAL FIELD

The present disclosure relates to an antenna.

### BACKGROUND

In recent years, the miniaturization of electronic devices has been accompanied by the use of antennas that are mounted on the substrate surfaces of dielectric substrates in some cases.

Examples of antennas mounted on a substrate surface include inverted-L antennas, inverted-F antennas, and meander line antennas (see, for example, JP 2011-142542A).

Such antennas have a linear or belt-like conductor that functions as an antenna element.

FIG. 34 is a diagram depicting one example of a conventional inverted-F antenna. In FIG. 34, three mutually perpendicular axes are set as the X axis, the Y axis, and the Z axis. On the X axis, one direction is set as the X1 direction and the opposite direction to the X1 direction is set as the X2 direction. Likewise, on the Y axis, one direction is set as the Y1 direction and the opposite direction to the Y1 direction is set as the Y2 direction. On the Z axis, one direction is set as the Z1 direction and the opposite direction to the Z1 direction is set as the Z2 direction.

In FIG. 34, an inverted-F antenna 100 includes a dielectric substrate 102, an antenna element 104, a feed conductor portion 106, a short-circuit conductor portion 108, a first ground conductor portion 109, and a second ground conductor portion 110.

Since the antenna element 104 of the inverted-F antenna 100 is mounted on the surface of a substrate, there can be a large drop in gain for the polarized wave components that are perpendicular to the substrate surface.

As one example, when the dielectric substrate 102 is disposed so as to be perpendicular to the X-Y plane, which is horizontal, as depicted in FIG. 34, radiation patterns of vertically polarized wave components and horizontally polarized wave components for the inverted-F antenna 100 are as depicted in FIG. 35.

FIG. 35(a) depicts a vertically polarized wave component (“V” in the drawing) and a horizontally polarized wave component (“H” in the drawing) on the X-Y plane in FIG. 34. FIG. 35(b) depicts a vertically polarized wave component (“V” in the drawing) and a horizontally polarized wave component (“H” in the drawing) on the Y-Z plane in FIG. 34. FIG. 35(c) depicts a vertically polarized wave component (“V” in the drawing) and a horizontally polarized wave component (“H” in the drawing) on the X-Z plane in FIG. 34.

In FIG. 35(a), “0” indicates the X1 direction and “90” indicates the Y1 direction. In FIG. 35(b), “0” indicates the Z1 direction and “90” indicates the Y1 direction. In FIG. 35(c), “0” indicates the Z1 direction and “90” indicates the X1 direction.

As can be understood from FIG. 35, the horizontally polarized wave component (H) on the X-Y plane has partial drops in the X1 and X2 directions. The vertically polarized wave component (V) on the Y-Z plane has partial drops in the Z1 and Z2 directions.

In particular, the gain of the horizontally polarized wave component (H) on the X-Z plane is extremely low in all directions.

In this way, for the inverted-F antenna 100, drops are observed in the gain of polarized wave components perpendicular to the substrate surface and in the gain of components perpendicular to the substrate surface out of polarized wave components.

Such drops in gain of polarized wave components perpendicular to the substrate surface are observed not only with inverted-F antennas but also with the inverted-L antennas and meander line antennas mentioned above that are mounted on a substrate surface.

It is an object of the present disclosure to provide a technology capable of suppressing drop in gain of polarized wave components perpendicular to a substrate surface.

### SUMMARY

An antenna according to an aspect of the present disclosure includes: a dielectric substrate; a feed conductor portion provided on the dielectric substrate; a first conductor portion that is provided on a substrate surface of the dielectric substrate, is connected to the feed conductor portion, and is linear or belt-like with one end as an open end; and a second conductor portion that is linear or belt-like and includes a first end portion and a second end portion on an opposite side to the first end portion, wherein the first end portion is connected to an intermediate portion between both ends of the first conductor portion, the second end portion is an open end, and the second conductor portion protrudes from the intermediate portion.

### Advantageous Effects

According to the present disclosure, it is possible to suppress a drop in gain of polarized wave components perpendicular to a substrate surface.

### BRIEF DESCRIPTION OF DRAWINGS

FIG. 1 is a perspective view depicting one example of an antenna according to a first embodiment.

FIG. 2 is an enlarged view of a principal part of a first surface of the antenna.

FIG. 3 is a view of the antenna as viewed from above, and a cross-sectional view of a principal part of the antenna.

FIG. 4 is a perspective view depicting one example of an antenna according to a second embodiment.

FIG. 5 is a side view of the antenna according to the second embodiment and a view of the antenna as viewed from above.

FIG. 6 is a perspective view depicting one example of an antenna according to a third embodiment.

FIG. 7 is an enlarged view of a principal part of the antenna and a cross-sectional view of a principal part of the antenna.

FIG. 8 is a perspective view of an antenna according to a fourth embodiment.

FIG. 9 is an enlarged view of a principal part of a first surface of an antenna according to a fifth embodiment.

FIG. 10 is a cross-sectional view of a principal part of an antenna according to a sixth embodiment.

FIG. 11 is a perspective view of an antenna according to a seventh embodiment.

FIG. 12 is a diagram depicting modifications to a connection between a first conductor portion and a second conductor portion.

FIG. 13 is a perspective view of an antenna according to an eighth embodiment.

FIG. 14 is a view of the antenna according to the eighth embodiment as viewed from above and a cross-sectional view of a principal part of the antenna.

FIG. 15 is a perspective view of a second end portion of a second conductor portion according to a modification to the eighth embodiment.

FIG. 16 is a cross-sectional view of a principal part of an antenna according to another modification to the eighth embodiment.

FIG. 17 is a diagram depicting modifications to a connection between a first conductor portion and a second conductor portion.

FIG. 18 is a diagram depicting another modification to a connection between a first conductor portion and a second conductor portion.

FIG. 19 is a diagram depicting radiation patterns of vertically polarized wave components and horizontally polarized wave components for Specific Example 1 and Comparative Example 1 on the X-Y plane.

FIG. 20 is a diagram depicting radiation patterns of vertically polarized wave components and horizontally polarized wave components for Specific Example 1 and Comparative Example 1 on the Y-Z plane.

FIG. 21 is a diagram depicting radiation patterns of vertically polarized wave components and horizontally polarized wave components for Specific Example 1 and Comparative Example 1 on the X-Z plane.

FIG. 22 is a diagram depicting radiation patterns of vertically polarized wave components and horizontally polarized wave components for Specific Example 2 and Comparative Example 1 on the X-Y plane.

FIG. 23 is a diagram depicting radiation patterns of vertically polarized wave components and horizontally polarized wave components for Specific Example 2 and Comparative Example 1 on the Y-Z plane.

FIG. 24 is a diagram depicting radiation patterns of vertically polarized wave components and horizontally polarized wave components for Specific Example 2 and Comparative Example 1 on the X-Z plane.

FIG. 25 is a diagram depicting radiation patterns of vertically polarized wave components and horizontally polarized wave components for Specific Example 3 and Comparative Example 2 on the X-Y plane.

FIG. 26 is a diagram depicting radiation patterns of vertically polarized wave components and horizontally polarized wave components for Specific Example 3 and Comparative Example 2 on the Y-Z plane.

FIG. 27 is a diagram depicting radiation patterns of vertically polarized wave components and horizontally polarized wave components for Specific Example 3 and Comparative Example 2 on the X-Z plane.

FIG. 28 is a diagram depicting radiation patterns of vertically polarized wave components and horizontally polarized wave components for Specific Example 4 and Comparative Example 2 on the X-Y plane.

FIG. 29 is a diagram depicting radiation patterns of vertically polarized wave components and horizontally polarized wave components for Specific Example 4 and Comparative Example 2 on the Y-Z plane.

FIG. 30 is a diagram depicting radiation patterns of vertically polarized wave components and horizontally polarized wave components for Specific Example 4 and Comparative Example 2 on the X-Z plane.

FIG. 31 is a diagram depicting the relationship between the difference in gain Δ for vertically polarized wave components on the X-Y plane and the length H of a second conductor portion 14.

FIG. 32 is a diagram depicting the relationship between the difference in gain Δ for horizontally polarized wave components on the X-Y plane and the length H of a second conductor portion 14.

FIG. 33 is a diagram depicting the relationship between the difference in gain Δ for vertically polarized wave components on the Y-Z plane and the length H of the second conductor portion 14.

FIG. 34 is a diagram depicting one example of a conventional inverted-F antenna.

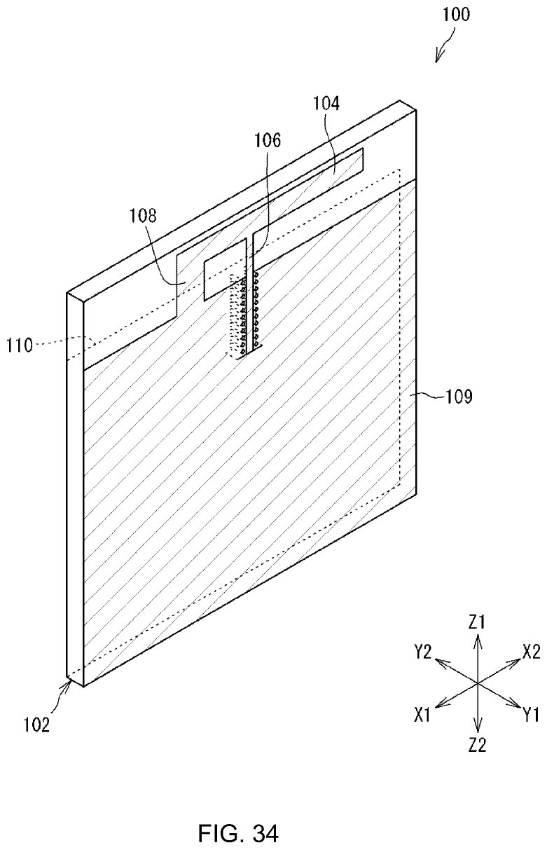

FIG. 35 is a diagram depicting radiation patterns for vertically polarized wave components and horizontally polarized wave components for a conventional inverted-F antenna.

### DETAILED DESCRIPTION OF PREFERRED EMBODIMENTS

Several embodiments of the present disclosure will first be listed and described in outline.

### Overview of Embodiments

In a first aspect, an antenna according to an embodiment of the present disclosure includes: a dielectric substrate; a feed conductor portion provided on the dielectric substrate; a first conductor portion that is provided on a substrate surface of the dielectric substrate, is connected to the feed conductor portion, and is linear or belt-like with one end as an open end; and a second conductor portion that is linear or belt-like and includes a first end portion and a second end portion on an opposite side to the first end portion. The first end portion is connected to an intermediate portion between both ends of the first conductor portion, the second end portion is an open end. The second conductor portion protrudes from the intermediate portion.

According to such a configuration, since the second conductor portion protrudes from the intermediate portion of the first conductor portion, the second conductor portion can excite polarized wave components that intersect the substrate surfaces.

As a result, it is possible to suppress the drop in gain of polarized wave components perpendicular to the substrate surface, and it is possible to compensate polarized wave components that would experience a drop in gain if only the first conductor portion were provided.

In a second aspect, in the antenna according to the first aspect, it is preferable for the dielectric substrate to include a retaining hole into which the first end portion is inserted.

With this configuration, it is easy to hold the second conductor portion in a protruding state from the intermediate portion.

In a third aspect, in the antenna according to the second aspect, the intermediate portion may include a through hole into which the first end portion is inserted.

With such a configuration, it is possible to hold the second conductor portion with the retaining hole even when the second conductor portion protrudes from the surface of the first conductor portion that is opposite the surface facing the dielectric substrate.

In a fourth aspect, in the antenna according to the first aspect, it is preferable for the first end portion to include a plate-shaped base end conductor portion that extends along the intermediate portion.

With such a configuration, the first end portion and the intermediate portion can be easily connected by placing the base end conductor portion facing the intermediate portion.

In a fifth aspect, it is preferable that the antenna according to the fourth aspect further include an insulating adhesive layer provided between the base end conductor portion and the intermediate portion.

With such a configuration, the insulating adhesive layer enables the intermediate portion and the second conductor portion to be fixed and capacitively coupled to each other.

In a sixth aspect, in the antenna according to any one of the first through the fifth aspects, it is preferable for the second end portion to include a plate-shaped conductor portion along an intersecting plane that intersects a length direction of the second conductor portion.

With such a configuration, the second end portion can be provided with an appropriate capacitance component, and even if the length of the second conductor portion is shortened, the drop in gain for polarized wave components that are perpendicular to the substrate surface can be suppressed in the same way as with a second conductor portion that does not include a plate-shaped conductor portion. As a result, the antenna as a whole can be miniaturized.

In a seventh aspect, in the antenna according to any one of the first through the sixth aspects, it is preferable for a ratio of a dimension in a length direction of the second conductor portion to a dimension in a length direction of the first conductor portion to be 0.36 or greater and 1.2 or lower.

If the ratio is less than 0.36, there is a risk that the effect of suppressing the drop in gain of polarized wave components perpendicular to the substrate surfaces will not be sufficient.

If the ratio is greater than 1.2, there is the risk of variation in the effect of suppressing the drop in gain of the polarized wave components perpendicular to the substrate surfaces, so that a stable effect may not be obtained.

By setting the ratio at 0.36 or greater and 1.2 or lower, it is possible to effectively suppress a drop in the gain of polarized wave components perpendicular to the substrate surfaces.

In an eighth aspect, in the antenna according to any one of the first through the seventh aspects, the first conductor portion may construct an inverted-F antenna.

With such a configuration, it is possible for the antenna to function as an inverted-F antenna.

In a ninth aspect, in the antenna according to any one of the first through the eighth aspects, the first conductor portion may construct an inverted-L antenna element.

With such a configuration, it is possible for the antenna to function as an inverted-L antenna.

In a tenth aspect, in the antenna according to any one of the first through the ninth aspects, the first conductor portion may construct a meander line structure.

With such a configuration, it is possible for the antenna to function as a meander line antenna.

Preferred embodiments of the present disclosure are described below with reference to the accompanying drawings.

Note that the embodiments described below may be freely combined, at least in part.

### First Embodiment

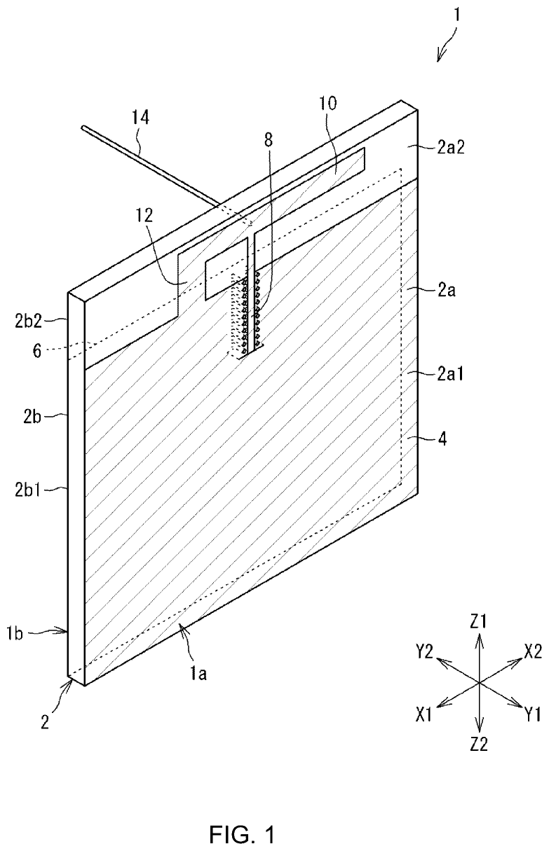

FIG. 1 is a perspective view depicting one example of an antenna according to a first embodiment.

As one example, the antenna 1 is an antenna used for wireless LAN communication. The antenna 1 is constructed of a conductor pattern formed on a substrate of an electronic device provided with a wireless LAN communication function.

Note that in the following description, three mutually perpendicular axes in the drawings are referred to as the X axis, the Y axis, and the Z axis. As depicted in FIG. 1, one direction on the X axis is referred to as the “X1 direction” and the opposite direction to the X1 direction is referred to as the “X2 direction”. One direction on the Y axis is referred to as the “Y1 direction” and the opposite direction to the Y1 direction is referred to as the “Y2 direction”. One direction on the Z axis is referred to as the “Z1 direction” and the opposite direction to the Z1 direction is referred to as the “Z2 direction”.

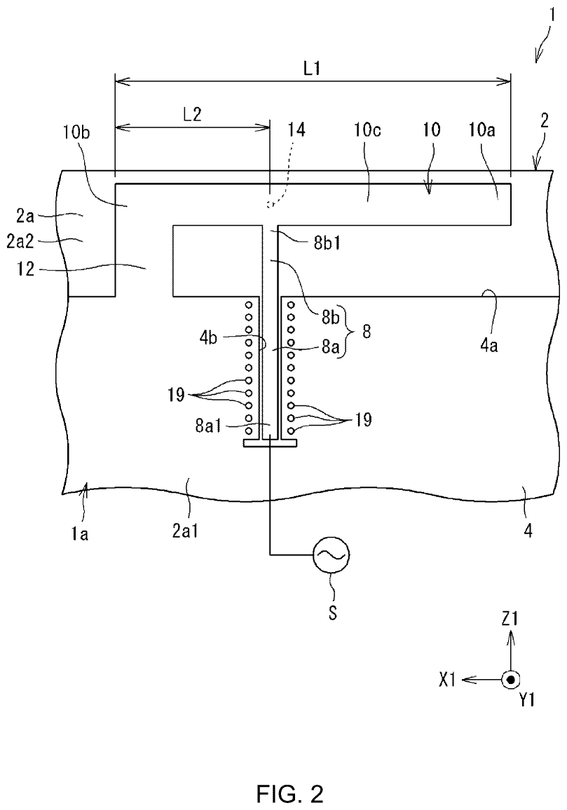

FIG. 2 is an enlarged view of a principal part of a first surface 1a of the antenna 1. The first surface 1a is the surface of the antenna 1 that faces the Y1 direction.

As depicted in FIGS. 1 and 2, the antenna 1 includes a dielectric substrate 2, a first ground conductor portion 4, a second ground conductor portion 6, a feed conductor portion 8, a first conductor portion 10, a short-circuit conductor portion 12, and a second conductor portion 14.

In the present embodiment, the X-Y plane is the horizontal plane. The Z1 direction is the upward direction, and the Z2 direction is the downward direction. In the present embodiment, it is assumed that the antenna 1 is installed so that the first surface 1a is parallel to the X-Z plane as depicted in FIG. 1. In other words, it is assumed that the antenna 1 is installed so that the first surface 1a is perpendicular to the horizontal plane.

It is also assumed that the antenna 1 is disposed so that the first conductor portion 10 is located at the top (that is, in the Z1 direction).

The dielectric substrate 2 is a substrate on which the first conductor portion 10, the short-circuit conductor portion 12, and the like are mounted. Although the dielectric substrate 2 is a rigid substrate, it is also possible to use a flexible substrate. Example materials for the dielectric substrate 2 include polyimide resin, epoxy resin, PPE resin, and fluororesin.

The first ground conductor portion 4 is a conductor pattern provided on the first substrate surface 2a. This conductor pattern is made of a conductor such as copper. The first substrate surface 2a is the surface of the dielectric substrate 2 on the first surface 1a side of the antenna 1.

The second ground conductor portion 6 is a conductor pattern provided on a second substrate surface 2b. The second substrate surface 2b is a surface of the dielectric substrate 2 on the second substrate surface 1b side of the antenna 1. The second substrate surface 1b is the surface of the antenna 1 that faces the Y2 direction.

The first ground conductor portion 4 and the second ground conductor portion 6 are provided in ranges of the first surface 1a and the second surface 1b that excludes a rectangular portion along an edge portion on the Z1 direction side of the dielectric substrate 2.

Accordingly, the first substrate surface 2a includes a first region 2a1 and a second region 2a2. The first region 2al is a region that is covered by the first ground conductor portion 4. The second region 2a2 is a region of the first substrate surface 2a that excludes the first region 2a1.

Similarly, the second substrate surface 2b includes a third region 2b1 and a fourth region 2b2. The third region 2b1 is a region that is covered by the second ground conductor portion 6. The fourth region 2b2 is a region of the second substrate surface 2b that excludes the third region 2b1.

The first conductor portion 10, the short-circuit conductor portion 12, and the feed conductor portion 8 are conductor patterns provided in the second region 2a2 on the first substrate surface 2a.

As depicted in FIG. 2, the first ground conductor portion 4 includes a slit 4b. The slit 4b extends in the Z2 direction from an edge portion 4a of the first ground conductor portion 4. The edge portion 4a extends along the X axis. The slit 4b is provided in the center in the X axis of the edge portion 4a.

Note that the slit 4b may be provided at a position that is displaced from the center in the X axis of the first surface 1a.

The first ground conductor portion 4 is not provided at the slit 4b part of the first substrate surface 2a. The part of the first substrate surface 2a with the slit 4b is therefore the “second region 2a2”.

A plurality of vias 19 are provided on both sides in the X axis of the slit 4b. The plurality of vias 19 are column-shaped members made of a conductor, such as copper, that pass through the dielectric substrate 2. One end of each of the plurality of vias 19 is connected to the second ground conductor portion 6. The other end of each of the plurality of vias 19 is connected to the first ground conductor portion 4. By doing so, the plurality of vias 19 connect the second ground conductor portion 6 and the first ground conductor portion 4. The plurality of vias 19 are arranged in rows along the slit 4b.

Note that in the present embodiment, the vias 19 and the first ground conductor portion 4 being “connected” refers to the vias 19 and the first ground conductor portion 4 being electrically connected. This state of the vias 19 and the first ground conductor portion 4 being electrically connected includes a case where the vias 19 and the first ground conductor portion 4 are in direct contact with each other or conduct electricity via another conductor, as well as a case where the vias 19 and the first ground conductor portion 4 are capacitively coupled to each other to form a high-frequency connection. This also applies to how the expression “connecting” is used for conductors in the following explanation.

The feed conductor portion 8 passes through the slit 4b and is connected to the first conductor portion 10. The feed conductor portion 8 extends along the Z axis.

The feed conductor portion 8 includes a first feed line 8a and a second feed line 8b.

Out of the feed conductor portion 8, the first feed line 8a is the part provided inside the slit 4b. Small gaps are provided between both edges on the X axis of the first feed line 8a and the edges of the first ground conductor portion 4 at the slit 4b.

The first feed line 8a forms a coplanar line together with the first ground conductor portion 4 positioned on both sides of the first feed line 8a.

The first feed line 8a includes a feed point 8a1. The feed point 8al is provided at the Z2 direction side-end of the first feed line 8a. A signal source S, such as a communication module for wireless LAN communication, is connected to the feed point 8a1. The communication module has a function of processing high-frequency signals transmitted and received by the antenna 1.

The second feed line 8b is the part of the feed conductor portion 8 aside from the first feed line 8a, and is the part in a range from the edge portion 4a to the first conductor portion 10.

An end portion 8b1 of the second feed line 8b is connected to the first conductor portion 10.

By doing so, the feed conductor portion 8 including the feed point 8al is connected to the first conductor portion 10. Accordingly, a high frequency signal provided to the feed point 8a1 is provided to the first conductor portion 10.

As mentioned earlier, the first conductor portion 10 and the short-circuit conductor portion 12 are conductor patterns provided in the second region 2a2.

As depicted in FIG. 2, the first conductor portion 10 has a belt-like shape. The first conductor portion 10 extends along the X axis. In the second region 2a2, the first conductor portion 10 is disposed opposite the edge portion 4a with a predetermined interval in between.

Note that the expression “belt-like” refers to an elongated narrow shape with a constant width like a strip or belt, with a thickness that is smaller than the width. In the present specification, this refers to elongated narrow rectangular shapes like the first conductor portion 10 and the feed conductor portion 8.

The expression “linear” refers to an elongated narrow shape that has substantially equal dimensions in respectively perpendicular directions in a cross section that is perpendicular to the length direction. In the present specification, this refers to a cylindrical shape like the second conductor portion 14, or a quadrangular prism whose cross section is substantially square.

The first conductor portion 10 may be linear.

One end 10a of the first conductor portion 10 is an open end. On the other hand, the other end 10b of the first conductor portion 10 is connected to the short-circuit conductor portion 12. The short-circuit conductor portion 12 has a belt-like shape. The short-circuit conductor portion 12 extends along the Z2 direction from the Z2 direction-side edge of the first conductor portion 10. The short-circuit conductor portion 12 connects the other end 10b of the first conductor portion 10 and the first ground conductor portion 4.

In addition, the feed conductor portion 8 is connected to a position in the length direction of the first conductor portion 10 between the one end 10a and the other end 10b.

In this way, the first conductor portion 10 includes the one end 10a, which is an open end, and the feed conductor portion 8 is connected between this one end 10a and the other end 10b of the first conductor portion 10. That is, the first conductor portion 10 constructs an inverted-F antenna element, and the antenna 1 functions as an inverted-F antenna.

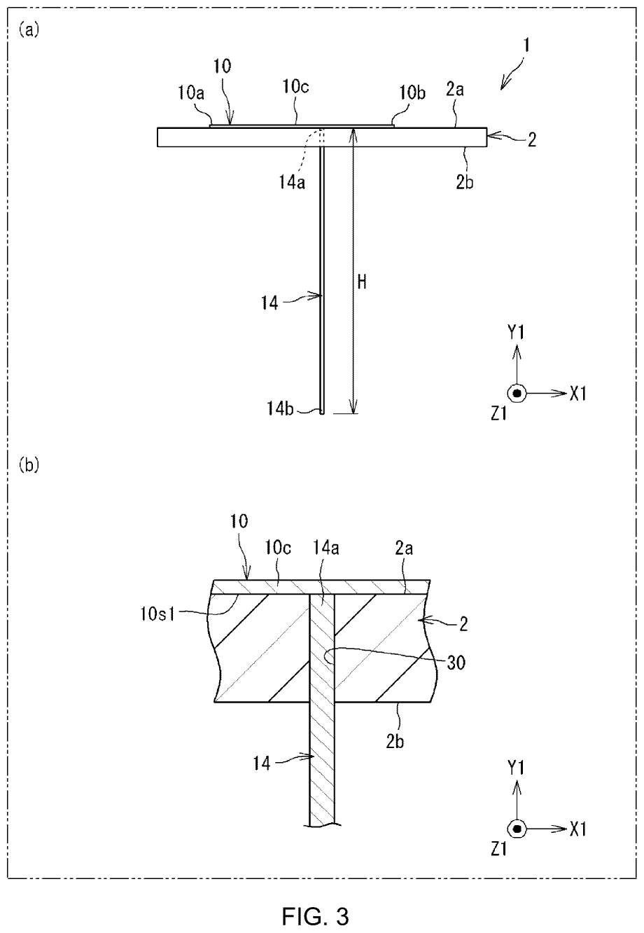

The second conductor portion 14 is provided on the first conductor portion 10. As depicted in FIG. 1, the second conductor portion 14 protrudes from the first conductor portion 10 in the Y2 direction. FIG. 3 is a view of the antenna 1 as viewed from above, and a cross-sectional view of a principal part of the antenna 1. FIG. 3(a) is a view of the antenna 1 as viewed from the Z1 direction (that is, from above).

As depicted in FIG. 3(a) and FIG. 1, the (main body portion of the) second conductor portion 14 is a linear solid (or in other words, cylindrical) member made of a conductor, such as copper.

The second conductor portion 14 protrudes from an intermediate portion 10c of the first conductor portion 10. This intermediate portion 10c is a part of the first conductor portion 10 located between the one end 10a and the other end 10b in the length direction.

The second conductor portion 14 includes a first end portion 14a and a second end portion 14b. The second end portion 14b is the opposite end to the first end portion 14a in the length direction of the second conductor portion 14.

The first end portion 14a is connected to a predetermined position on the intermediate portion 10c. Accordingly, a high-frequency signal provided to the feed point 8al is provided via the first conductor portion 10 to the second conductor portion 14.

The second end portion 14b is an open end.

As depicted in FIG. 2, the connection position on the X axis of the second conductor portion 14 is a position on the intermediate portion 10c a distance L2 from an X1 direction-side edge of the first conductor portion 10. In other words, the distance L2 is the distance along the X axis from the center of the second conductor portion 14 to the X1 direction-side edge of the first conductor portion 10. The connection position on the Z axis of the second conductor portion 14 is the center on the Z axis of the first conductor portion 10.

The connection position on the Z axis of the second conductor portion 14 may be displaced from the center on the Z axis of the first conductor portion 10.

In the present embodiment, the connection position of the second conductor portion 14 and the connection position of the feed conductor portion 8 are the same on the X axis. In other words, the connection position on the X axis of the second conductor portion 14 is the center on the X axis of the feed conductor portion 8.

FIG. 3(b) depicts the first end portion 14a part of the second conductor portion 14 in a cross section taken along the X-Y plane of the antenna 1.

The first conductor portion 10 and the second conductor portion 14 are fused together by welding, brazing, or soldering, for example.

The front end of the first end portion 14a of the second conductor portion 14 abuts a first surface 10s1 of the first conductor portion 10. Accordingly, the second conductor portion 14 protrudes from this first surface 10s1. The first surface 10s1 is the surface of the first conductor portion 10 that contacts the dielectric substrate 2.

The dielectric substrate 2 is provided with a retaining hole 30. The retaining hole 30 passes through the dielectric substrate 2 along the Y axis so as to connect the first substrate surface 2a and the second substrate surface 2b. The second conductor portion 14 is inserted into this retaining hole 30. The second conductor portion 14 passes through the retaining hole 30.

An inner circumferential surface of the retaining hole 30 and an outer circumferential surface of the second conductor portion 14 contact each other. By doing so, the retaining hole 30 holds the first end portion 14a of the second conductor portion 14.

The retaining hole 30 facilitates holding of the second conductor portion 14 in a state where the second conductor portion 14 protrudes from the first conductor portion 10.

Note that an adhesive layer may be formed between the inner circumferential surface of the retaining hole 30 and the outer circumferential surface of the first end portion 14a to fix the second conductor portion 14 and the dielectric substrate 2.

Here, the second conductor portion 14 protrudes from the intermediate portion 10c in a direction that is perpendicular to the substrate surfaces 2a and 2b.

This means that the second conductor portion 14 can excite polarized wave components that intersect the substrate surfaces 2a and 2b.

As a result, it is possible to suppress a drop in the gain of polarized wave components that are perpendicular to the substrate surfaces 2a and 2b, and possible to compensate for the polarized wave components for which a drop in gain occurs when only the first conductor portion 10 is used.

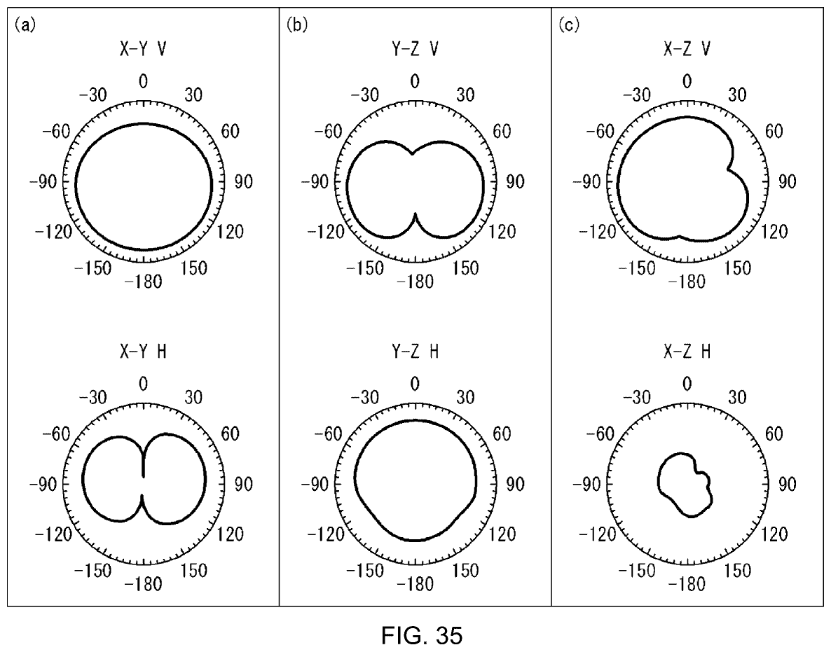

In more detail, with the antenna 1 according to the present embodiment, it is possible to suppress partial drops in gain observed for horizontally polarized wave components on the X-Y plane and vertically polarized wave components on the Y-Z plane as well as a drop in gain of horizontally polarized wave components on the X-Z plane, such as those depicted in FIG. 35.

In addition, in the present embodiment, since (the main body portion of) the second conductor portion 14 is cylindrical, it is possible to excite electromagnetic field components uniformly around the side surface of the second conductor portion 14.

Since the second conductor portion 14 in the present embodiment protrudes from the intermediate portion 10c along a direction perpendicular to the substrate surfaces 2a and 2b, a drop in gain of polarized wave components that are perpendicular to the substrate surfaces 2a and 2b can be more effectively suppressed.

Note that the length L1 on the X axis of the first conductor portion 10, the distance L2 along the X axis from the X1 direction-side edge of the first conductor portion 10 to the center of the second conductor portion 14, the width on the Z axis of the first conductor portion 10, the widths on the X axis and the Z axis of the short-circuit conductor portion 12, the length H of the second conductor portion 14 (that is, the height from the front end of the second end portion 14b to the first surface 10s1), the diameter of the second conductor portion 14, and the like are set as appropriate in keeping with the frequency of the high frequency signal provided to the feed point 8al and the polarization characteristics of the antenna 1, with consideration to the thickness of the dielectric substrate 2, the relative dielectric constant, the thicknesses of the conductor portions, and the like.

It is preferable for the length H of the second conductor portion 14 to satisfy the condition given below.

That is, it is preferable for the ratio of the dimension (or “length H”) in the length direction of the second conductor portion 14 to the dimension (or “length L1”) in the length direction of the first conductor portion 10 to be equal to or greater than 0.36 and equal to or lower than 1.2.

If the ratio is less than 0.36, there is a risk that the effect of suppressing the drop in gain of polarized wave components perpendicular to the substrate surfaces will not be sufficient.

If the ratio is greater than 1.2, there is the risk of variation in the effect of suppressing the drop in gain of the polarized wave components perpendicular to the substrate surfaces, so that a stable effect may not be obtained.

By setting the ratio at 0.36 or greater and 1.2 or lower, it is possible to effectively suppress a drop in the gain of polarized wave components perpendicular to the substrate surfaces.

### Second Embodiment

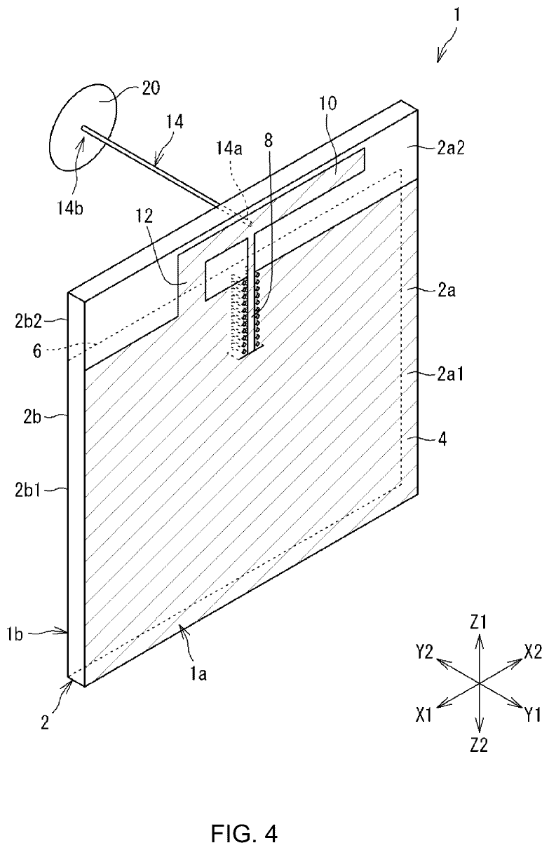

FIG. 4 is a perspective view depicting one example of an antenna according to a second embodiment.

This embodiment differs from the first embodiment in that the second conductor portion 14 includes a plate-shaped conductor portion 20.

The plate-shaped conductor portion 20 is a circular plate-shaped member made of a conductor, such as copper.

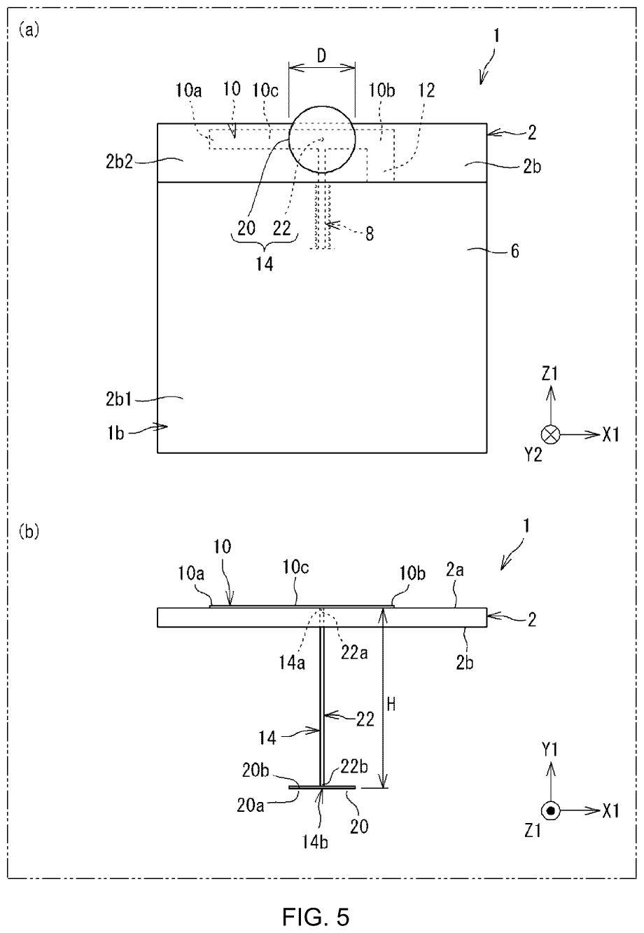

FIG. 5 is a side view of the antenna 1 according to the second embodiment and a view of the antenna 1 as viewed from above. FIG. 5(a) depicts the antenna 1 as viewed from the Y2 direction. FIG. 5(b) depicts the antenna 1 as viewed from the Z1 direction.

The second conductor portion 14 includes the plate-shaped conductor portion 20 mentioned above and a main body portion 22.

The main body portion 22 is a solid linear (cylindrical) member made of a conductor, such as copper. One end 22a of the main body portion 22 constructs the first end portion 14a of the second conductor portion 14. Accordingly, the one end 22a is connected to the intermediate portion 10c.

The plate-shaped conductor portion 20 is fixed to the front of another end 22b of the main body portion 22. Accordingly, the second end portion 14b of the second conductor portion 14 includes this other end 22b and the plate-shaped conductor portion 20.

A first surface 20a and a second surface 20b of the plate-shaped conductor portion 20 are parallel to the X-Z plane. This means that the first surface 20a and the second surface 20b extend along an intersecting plane that intersects the length direction of the second conductor portion 14.

The first surface 20a is the surface of the plate-shaped conductor portion 20 that faces the Y2 direction. The second surface 20b is the surface of the plate-shaped conductor portion 20 that faces the Y1 direction.

The other end 22b abuts the center of the second surface 20b of the plate-shaped conductor portion 20. The other end 22b and the plate-shaped conductor portion 20 are fused together by welding or brazing, for example. By doing so, the other end 22b of the main body portion 22 and the plate-shaped conductor portion 20 are interconnected.

In the present embodiment, since the second end portion 14b of the second conductor portion 14 includes the plate-shaped conductor portion 20, an appropriate capacitance component can be provided at the second end portion 14b, so that even when the length H of the second conductor portion 14 is reduced, the drop in gain of polarized wave components that are perpendicular to the substrate surfaces can be suppressed in the same way as with a second conductor portion 14 that does not include the plate-shaped conductor portion 20. As a result, the antenna 1 as a whole can be miniaturized.

Note that the diameter D of the plate-shaped conductor portion 20 (that is, the area of the first surface 20a and the second surface 20b), the thickness of the plate-shaped conductor portion 20, and the length H of the second conductor portion 14 are set as appropriate in keeping with the dimensions of the other parts, the frequency of the high-frequency signal applied to the feed point 8al, and the polarization characteristics of the antenna 1.

### Third Embodiment

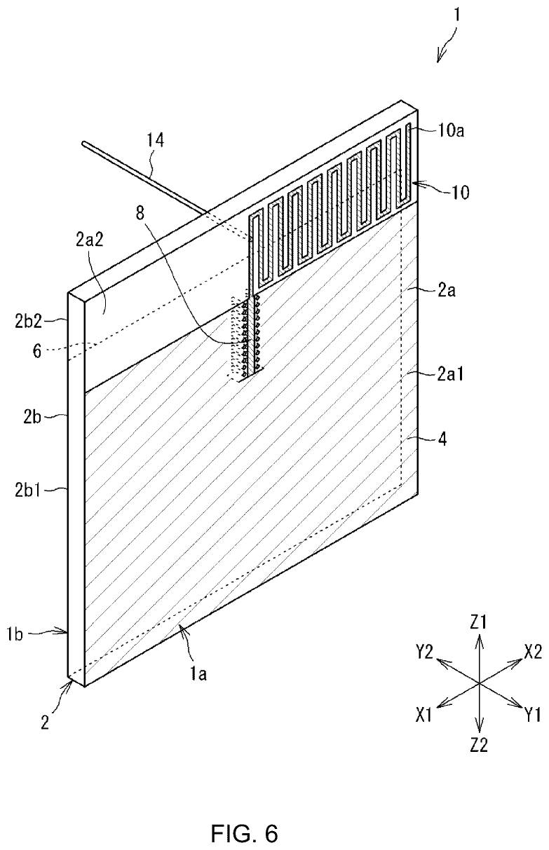

FIG. 6 is a perspective view depicting one example of an antenna according to a third embodiment.

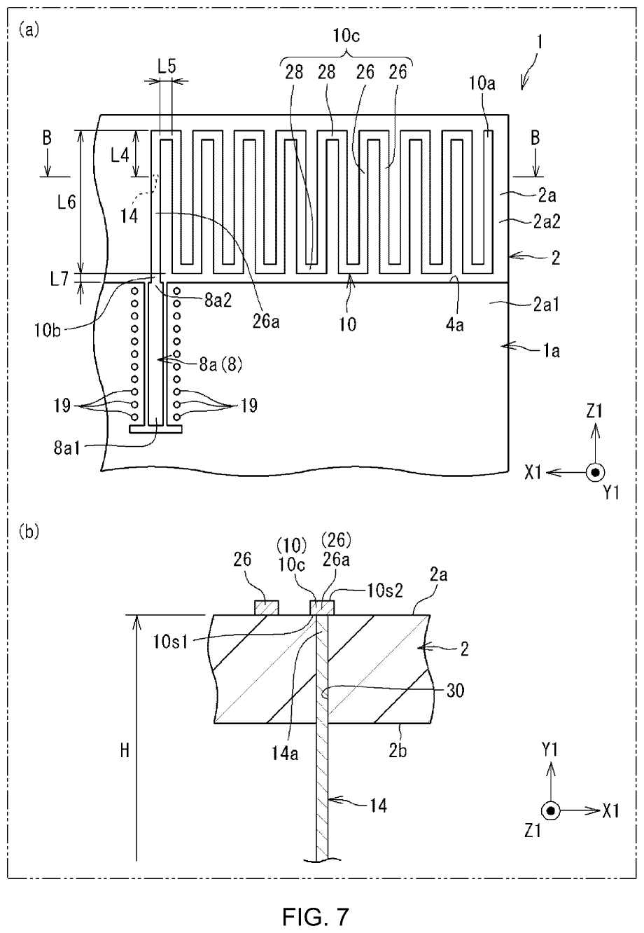

FIG. 7 is an enlarged view of a principal part of the antenna 1 and a cross-sectional view of a principal part of the antenna 1. FIG. 7(a) depicts a principal part of the first surface 1a of the antenna 1. FIG. 7(b) depicts a cross-section taken along a line B-B in FIG. 7(a).

The present embodiment differs from the first embodiment in that the first conductor portion 10 has a meander line structure.

As depicted in FIG. 7, the other end 10b of the first conductor portion 10 is connected to another end 8a2 of the first feed line 8a. By doing so, the feed point 8al of the feed conductor portion 8 and the first conductor portion 10 are interconnected.

For this reason, the feed conductor portion 8 according to the present embodiment does not include the second feed line 8b.

As described above, the first conductor portion 10 has a meander line structure. For this reason, the antenna 1 functions as a meander line antenna.

The expression “meander line structure” refers to a structure in which a linear or belt-like conductor meanders.

As depicted in FIG. 7(a), the intermediate portion 10c of the first conductor portion 10 includes a plurality of first lines 26 that are parallel to the Z axis and a plurality of second lines 28 that are parallel to the X axis. The first lines 26 are disposed at equal intervals on the X axis. Each of the plurality of second lines 28 connects end portions of a pair of adjacent first lines 26 out of the plurality of first lines 26. By doing so, the first conductor portion 10 has a meander line structure.

The overall length of the first conductor portion 10 (that is, the overall length at the center in the width direction) is set as appropriate in keeping with the frequency of the high-frequency signal provided to the feed point 8a1.

The second conductor portion 14 is provided on one line 26a out of the plurality of first lines 26. This line 26a is a line out of the plurality of first lines 26 that is connected to the first feed line 8a.

Note that a distance L6 is the distance along the Z axis from the Z1 direction-side edge of the intermediate portion 10c to the Z2 direction-side edge for lines aside from the line 26a.

A distance L7 is the distance from the Z2-side edge of the intermediate portion 10c to the edge portion 4a of the first ground conductor portion 4 for lines aside from the line 26a.

A distance L4 is the distance along the Z axis from the Z1-side edge of the first conductor portion 10 to the center of the second conductor portion 14. A distance L5 is the interval between a pair of adjacent first lines 26 out of the plurality of first lines 26. The distance L5 does not include the width of the first lines 26.

Note that although the second conductor portion 14 is provided on the line 26a in the present embodiment, the second conductor portion 14 may be provided in a part (as examples, the plurality of first lines 26 and the plurality of second lines 28) of the intermediate portion 10c aside from the line 26a.

Note that it is preferable for the second conductor portion 14 to be provided at a part of the intermediate portion 10c that is close to the feed conductor portion 8, such as at the line 26a.

As depicted in FIG. 7(b), the first end portion 14a of the second conductor portion 14 is connected to the intermediate portion 10c of the first conductor portion 10. The first conductor portion 10 and the second conductor portion 14 are fused together.

The second conductor portion 14 protrudes from the line 26a in the Y2 direction. In other words, the second conductor portion 14 protrudes from the first surface 10s1.

In the present embodiment also, it is possible to suppress a drop in gain of polarized wave components that are perpendicular to the substrate surfaces.

Note that the distances L4, L5, L6, and L7, the width on the X axis of the first lines 26, the width on the Z axis of the second lines 28, the length H of the second conductor portion 14 (that is, the height from the front end of the second end portion 14b to the first surface 10s1), the diameter of the second conductor portion 14, and the like are set as appropriate in keeping with the frequency of the high frequency signal applied to the feed point 8al and the polarization characteristics of the antenna 1, with consideration to the thickness of the dielectric substrate 2, the relative dielectric constant, the thicknesses of the respective conductor portions, and the like.

### Fourth Embodiment

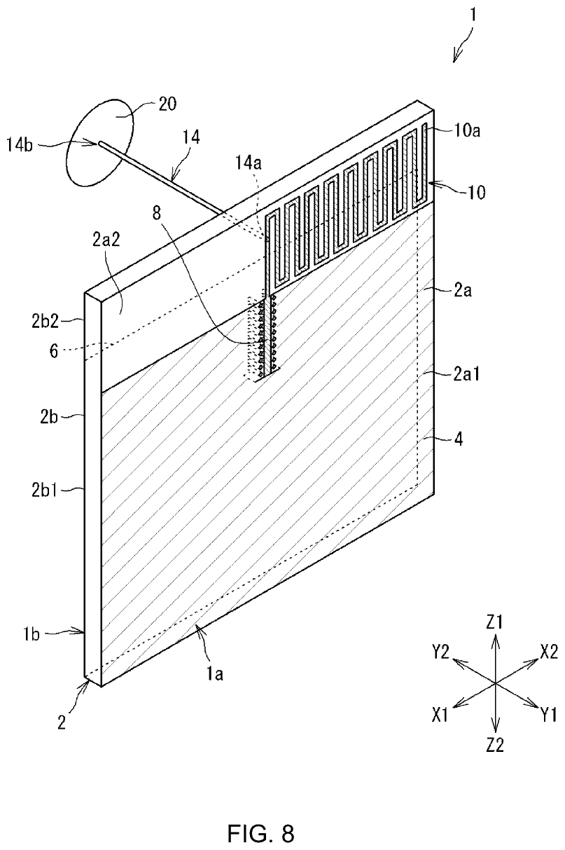

FIG. 8 is a perspective view of an antenna 1 according to the fourth embodiment.

The present embodiment differs from the third embodiment in that the second conductor portion 14 includes a plate-shaped conductor portion 20.

The plate-shaped conductor portion 20 is provided at the second end portion 14b of the second conductor portion 14. The configuration of the plate-shaped conductor portion 20 is the same as in the second embodiment depicted in FIG. 6.

In this case as well, the length H of the second conductor portion 14 can be made shorter than a second conductor portion 14 that does not include the plate-shaped conductor portion 20.

### Fifth Embodiment

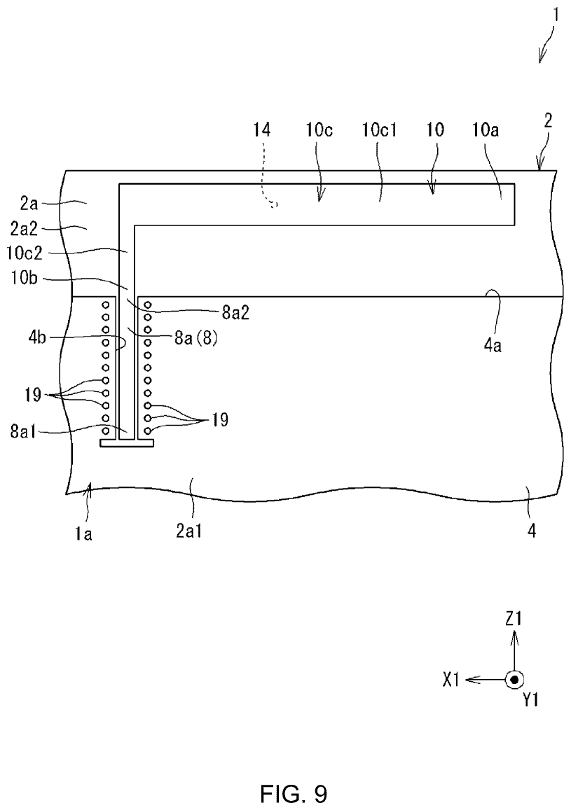

FIG. 9 is an enlarged view of a principal part of the first surface 1a of the antenna 1 according to the fifth embodiment.

The present embodiment differs from the first embodiment by not including the short-circuit conductor portion 12 and having a first conductor portion 10 that is formed in an L shape.

That is, the antenna 1 according to the present embodiment functions as an inverted-L antenna, and the first conductor portion 10 in the present embodiment constructs an inverted-L antenna element.

As depicted in FIG. 9, the intermediate portion 10c of the first conductor portion 10 includes a main body portion 10cl that extends along the X axis and a bent portion 10c2 that extends along the Z axis. The main body portion 10cl connects the one end 10a to the bent portion 10c2. The bent portion 10c2 connects the other end 10b to the main body portion 10c1.

The second conductor portion 14 is provided on the main body portion 10c1.

The other end 10b of the first conductor portion 10 is connected to the other end 8a2 of the first feed line 8a. By doing so, the feed point 8al of the feed conductor portion 8 and the first conductor portion 10 are interconnected.

For this reason, the feed conductor portion 8 in the present embodiment does not include the second feed line 8b.

In the present embodiment also, it is possible to suppress a drop in gain of polarized wave components that are perpendicular to the substrate surfaces.

Note that although an example where the second conductor portion 14 is provided on the main body portion 10cl is illustrated in the present embodiment, the second conductor portion 14 may be provided on the bent portion 10c2.

### Sixth Embodiment

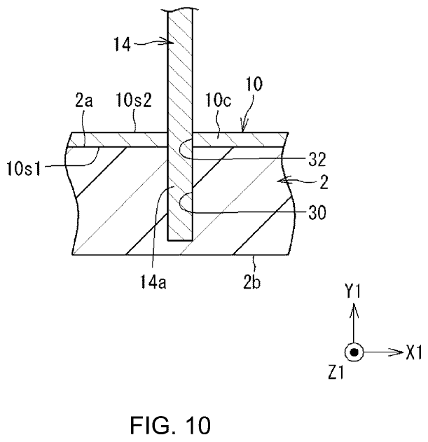

FIG. 10 is a cross-sectional view of a principal part of an antenna 1 according to a sixth embodiment.

The present embodiment differs from the first embodiment in that the second conductor portion 14 protrudes in the Y1 direction from the first conductor portion 10.

As depicted in FIG. 10, the second conductor portion 14 is inserted into the retaining hole 30 and the through hole 32.

The through hole 32 passes through the intermediate portion 10c of the first conductor portion 10 so as to connect the first surface 10s1 and the second surface 10s2. The second surface 10s2 is the opposite surface to the first surface 10s1. The inner diameter of the through hole 32 is substantially the same as the inner diameter of the retaining hole 30. The center of the inner circumferential surface of the through hole 32 and the center of the inner circumferential surface of the retaining hole 30 coincide with each other.

In the present embodiment, the retaining hole 30 is a bottomed hole that is open to the first substrate surface 2a only. Accordingly, when the first end portion 14a of the second conductor portion 14 is inserted into the retaining hole 30, it is easy to position the second conductor portion 14 relative to the dielectric substrate 2.

The first end portion 14a of the second conductor portion 14 is inserted into the retaining hole 30 and the through hole 32. In this state, the first conductor portion 10 and the second conductor portion 14 are fused together by welding, brazing, or soldering, for example.

In this way, in the present embodiment, the intermediate portion 10c has the through hole 32 into which the first end portion 14a is inserted. By doing so, it is possible to hold the second conductor portion 14 with the retaining hole 30 even when the second conductor portion 14 is caused to protrude from the second surface 10s2 of the first conductor portion 10 that is on the opposite side to the first surface 10s1.

### Seventh Embodiment

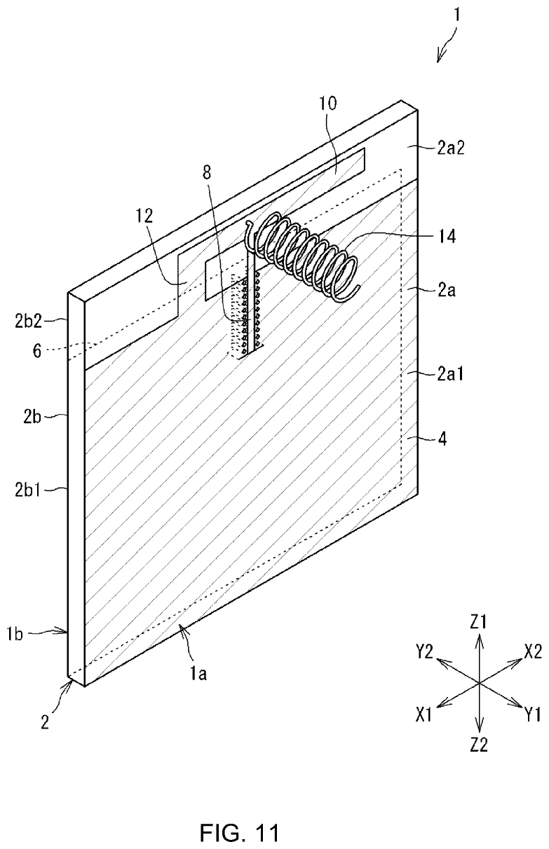

FIG. 11 is a perspective view of an antenna 1 according to a seventh embodiment.

The present embodiment differs from the sixth embodiment in that the second conductor portion 14 has a spiral shape.

In the present embodiment, the second conductor portion 14 is obtained by forming a wire made of a conductor into a spiral shape. In this case as well, it is possible to suppress a drop in gain of polarized wave components that are perpendicular to the substrate surfaces.

### Modifications of Connection Between First Conductor Portion 10 and Second Conductor Portion 14

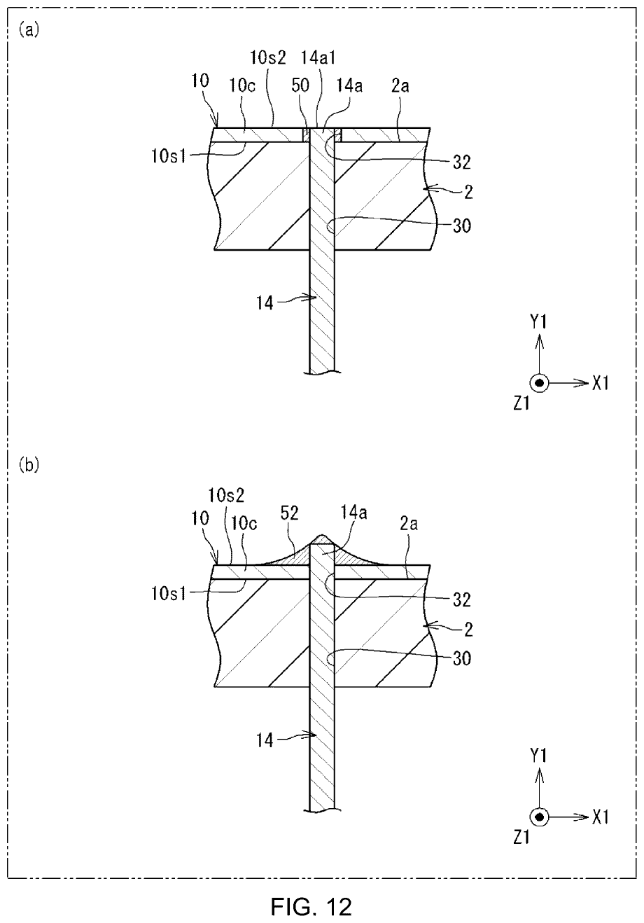

FIG. 12 is a diagram depicting modifications to a connection between the first conductor portion 10 and the second conductor portion 14. FIG. 12 depicts a case where the second conductor portion 14 protrudes from the first conductor portion 10 in the Y2 direction.

The modification depicted in FIG. 12(a) differs from the first embodiment in that the second conductor portion 14 is inserted into the through hole 32.

The through hole 32 in the intermediate portion 10c passes through the intermediate portion 10c of the first conductor portion 10 so as to connect the first surface 10s1 and the second surface 10s2. The inner diameter of the through hole 32 is larger than the outer diameter of the first end portion 14a of the second conductor portion 14. A ring-shaped fused portion 50 is provided between the inner circumferential surface of the through hole 32 in the intermediate portion 10c and the outer circumferential surface of the first end portion 14a of the second conductor portion 14.

The fused portion 50 is formed of solder, for example. The fused portion 50 is formed as follows. First, the first end portion 14a of the second conductor portion 14 is inserted into the retaining hole 30 and the through hole 32, and the second conductor portion 14 is fixed to the dielectric substrate 2. At this time, the position on the Y axis of an end surface 14al of the first end portion 14a is aligned with the position on the Y axis of the second surface 10s2 of the first conductor portion 10.

Next, molten solder is poured into a ring-shaped space between the inner circumferential surface of the through hole 32 and the outer circumferential surface of the first end portion 14a to form the fused portion 50.

In this modification, the first conductor portion 10 and the second conductor portion 14 are connected by the fused portion 50 interposed between the inner circumferential surface of the through hole 32 and the outer circumferential surface of the first end portion 14a.

The second conductor portion 14 is held on and fixed to the dielectric substrate 2 by the retaining hole 30 and the fused portion 50.

The modification depicted in FIG. 12(b) differs from the first embodiment [0204] in that the first end portion 14a of the second conductor portion 14 slightly protrudes from the second surface 10s2 of the first conductor portion 10.

In this modification also, the second conductor portion 14 is inserted into the retaining hole 30 and the through hole 32.

The inner diameter of the through hole 32 is substantially equal to the inner diameter of the retaining hole 30. The center of the inner circumferential surface of the through hole 32 and the center of the inner circumferential surface of the retaining hole 30 coincide with each other. Accordingly, the inner circumferential surface of the through hole 32 contacts the outer circumferential surface of the first conductor portion 10.

A fused portion 52 is provided on the second surface 10s2 of the first conductor portion 10. The fused portion 52 is formed from solder, for example. The fused portion 52 is formed so as to cover the outer surface of the first end portion 14a that protrudes from the second surface 10s2 and the periphery of the first end portion.

The first conductor portion 10 and the second conductor portion 14 are connected by this fused portion 52.

The second conductor portion 14 is held on and fixed to the dielectric substrate 2 by the retaining hole 30 and the fused portion 52.

Note that although a configuration where the second conductor portion 14 protrudes from the first conductor portion 10 in the Y2 direction is depicted in FIG. 12, even when the second conductor portion 14 protrudes from the first conductor portion 10 in the Y1 direction, it is possible to connect the first conductor portion 10 and the second conductor portion 14 using a similar configuration to the configurations depicted in FIG. 12.

Although the position on the Y axis of the end surface 14al of the first end portion 14a is aligned with the position on the Y axis of the second surface 10s2 of the first conductor portion 10 in FIG. 12(a), it is also possible to dispose the second conductor portion 14 so as to protrude in the Y1 direction from the second surface 10s2 of the first conductor portion 10. By doing so, it is possible to connect the first conductor portion 10 and the second conductor portion 14 using the configuration depicted in FIG. 12(a) while enabling the second conductor portion 14 to protrude from the first conductor portion 10 in the Y1 direction.

Although the first end portion 14a protruding from the second surface 10s2 is covered with the fused portion 52 in FIG. 12(b), the second conductor portion 14 can be caused to protrude in the Y1 direction from the fused portion 52. By doing so, it is possible to connect the first conductor portion 10 and the second conductor portion 14 using the configuration depicted in FIG. 12(b) while enabling the second conductor portion 14 to protrude from the first conductor portion 10 in the Y1 direction.

Although the modifications depicted in FIG. 12 are depicted as modifications to the first embodiment, such modifications can also be applied to the embodiments described earlier that use a linear second conductor portion 14.

### Eighth Embodiment

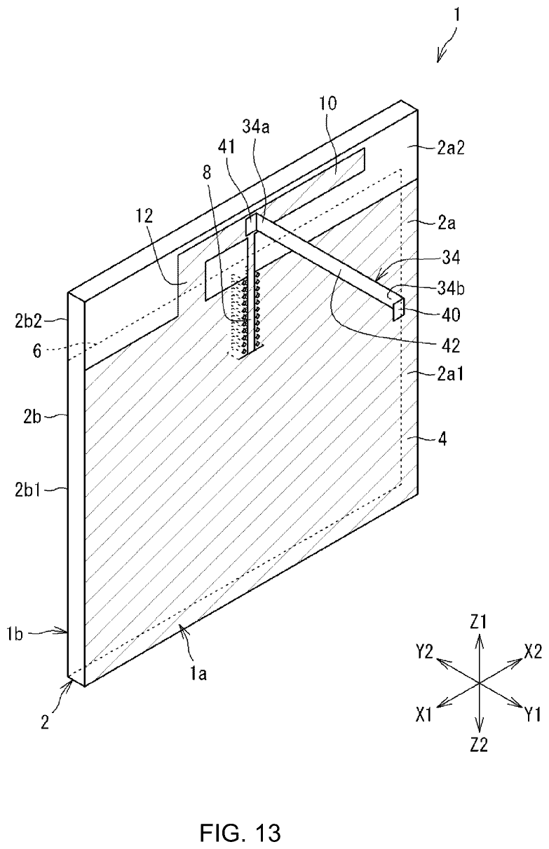

FIG. 13 is a perspective view of an antenna 1 according to an eighth embodiment.

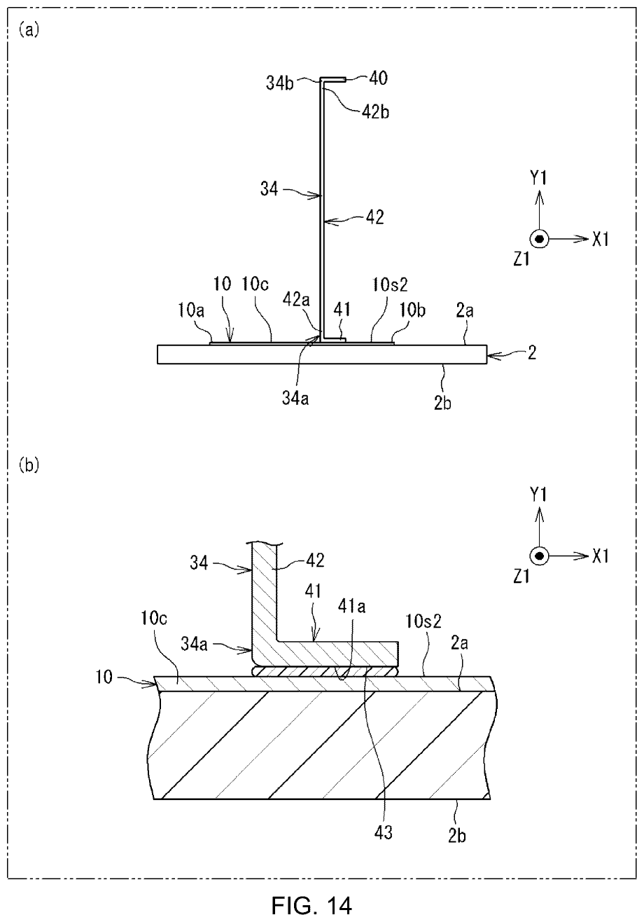

FIG. 14 is a view of the antenna 1 according to the eighth embodiment as viewed from above and a cross-sectional view of a principal part of the antenna 1. FIG. 14(a) is a view of the antenna 1 as viewed from the Z1 direction.

This embodiment differs from the first embodiment in that a second conductor portion 34 has a belt-like shape.

This embodiment also differs from the first embodiment in that the second conductor portion 34 protrudes in the Y1 direction.

The second conductor portion 34 includes a main body portion 42, a plate-shaped conductor portion 40, and a base end conductor portion 41.

The second conductor portion 34 in the present embodiment is formed by bending both ends of a conductor member that has a belt-like shape. at right angles. This means that the main body portion 42 has a belt-like shape. The plate-shaped conductor portion 40 and the base end conductor portion 41 are shaped as rectangular plates. The width dimensions along the Z axis of the main body portion 42, the plate-shaped conductor portion 40, and the base end conductor portion 41 are the same. The width dimensions along the Z axis of the main body portion 42, the plate-shaped conductor portion 40, and the base end conductor portion 41 are equal to or less than the width dimension along the Z axis of the first conductor portion 10.

As depicted in FIG. 14(a), the base end conductor portion 41 is connected to one end 42a of the main body portion 42.

The plate-shaped conductor portion 40 is connected to another end 42b of the main body portion 42.

A second end portion 34b of the second conductor portion 34 includes the other end 42b and the plate-shaped conductor portion 40. The plate-shaped conductor portion 40 extends along the X1 direction from the other end 42b.

As described earlier, the length along the Y axis of the second conductor portion 34 when the second end portion 34b includes the plate-shaped conductor portion 40 can be made shorter than the length of the second end portion 34b when the plate-shaped conductor portion 40 is not included.

A first end portion 34a of the second conductor portion 34 includes the one end 42a and the base end conductor portion 41. The base end conductor portion 41 extends from the one end 42a along the X1 direction.

The base end conductor portion 41 is fixed to the intermediate portion 10c. By doing so, the second conductor portion 34 (that is, the main body portion 42) protrudes from the first conductor portion 10 in the Y1 direction.

The base end conductor portion 41 is disposed along the intermediate portion 10c. That is, the base end conductor portion 41 faces the intermediate portion 10c.

FIG. 14(b) depicts the first end portion 34a of the second conductor portion 34, out of a cross section of the antenna 1 taken along the X-Y plane.

The base end conductor portion 41 has a first surface 41a that faces the first conductor portion 10. The first surface 41a faces the second surface 10s2. The first surface 41a is a surface that faces the opposite side to the main body portion 42.

An insulating adhesive layer 43 is provided between the first surface 41a and the second surface 10s2 and fixes the base end conductor portion 41 to the second surface 10s2.

The insulating adhesive layer 43 is made of an insulating resin, for example. As specific examples, the insulating adhesive layer 43 is formed using insulating resin adhesive or double-sided tape that is electrically insulating.

A high-frequency connection is formed between the base end conductor portion 41 and the first conductor portion 10. In other words, the base end conductor portion 21 and the first conductor portion 10 are capacitively coupled. By doing so, the high-frequency signal provided to the feed point 8al is transmitted between the first conductor portion 10 and the base end conductor portion 41 and provided to the second conductor portion 34.

Note that the area of the first surface 41a, the thickness of the insulating adhesive layer 43, the dielectric constant of the insulating adhesive layer 43, and the like are set as appropriate in keeping with the frequency of the high-frequency signal provided to the feed point 8al and the polarization characteristics of the antenna 1.

In the present embodiment, since the first end portion 34a of the second conductor portion 34 includes the plate-shaped base end conductor portion 41 that extends along the intermediate portion 10c, it is possible to easily connect the first end portion 34a of the second conductor portion 34 to the intermediate portion 10c by placing the base end conductor portion 41 facing the intermediate portion 10c.

In the present embodiment, since the insulating adhesive layer 43 is provided between the base end conductor portion 41 and the intermediate portion 10c, the intermediate portion 10c and the second conductor portion 34 can be fixed and capacitively coupled to each other.

Also in the present embodiment, since the second conductor portion 34 includes the belt-like main body portion 42, it is easy to machine the second conductor portion 34 into a desired shape, such as by bending one end of a belt-like conductor member to provide the base end conductor portion 41 at the one end 42a of the main body portion 42.

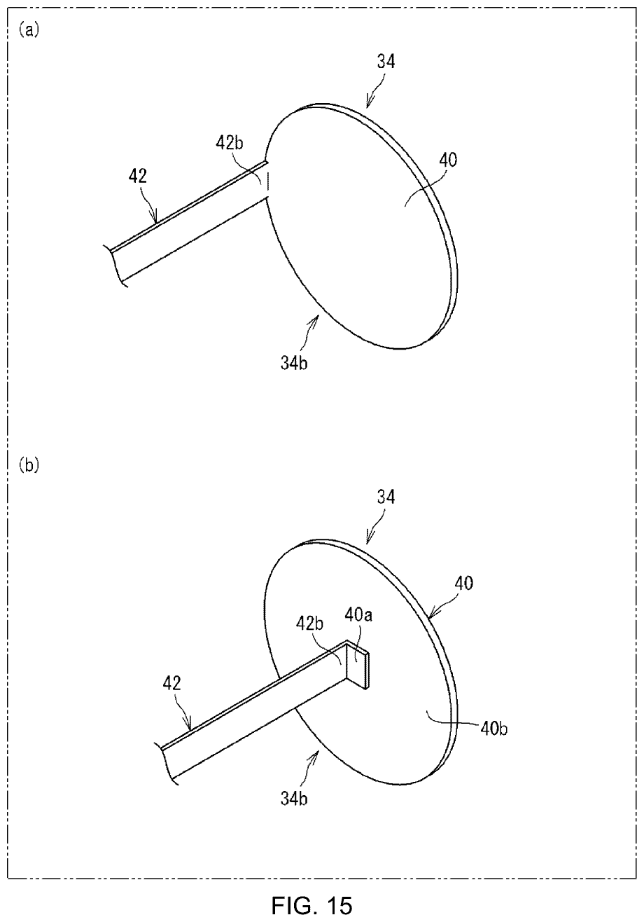

FIG. 15 is a perspective view of a second end portion 34b of the second conductor portion 34 according to a modification to the eighth embodiment.

In this eighth embodiment, the case where the plate-shaped conductor portion 40 is rectangular is depicted.

However, as depicted in FIG. 15(a), the plate-shaped conductor portion 40 may be formed in a circular shape.

In the modification in FIG. 15(a), the main body portion 42 and the plate-shaped conductor portion 40 are formed by bending a single conductor plate. This means that the other end 42b of the main body portion 42 is connected to the edge of the plate-shaped conductor portion 40.

Also, as depicted in FIG. 15(b), the plate-shaped conductor portion 40 may include a bent portion 40a and a plate-shaped portion 40b.

The bent portion 40a is provided by bending a single conductor plate in the same way as the plate-shaped conductor portion 40 in the eighth embodiment in a state where the conductor plate is connected to the other end 42b.

The plate-shaped portion 40b is formed in a circular shape.

As examples, the bent portion 40a and the plate-shaped portion 40b are fixed to each other by fusing such as welding, brazing, or soldering, or by an adhesive layer made of insulating resin or the like.

The bent portion 40a is fixed to substantially the center of the plate-shaped portion 40b.

According to this modification, when a plate-shaped second conductor portion 34 is used, it is easy to change the shape and area of the plate-shaped conductor portion 40.

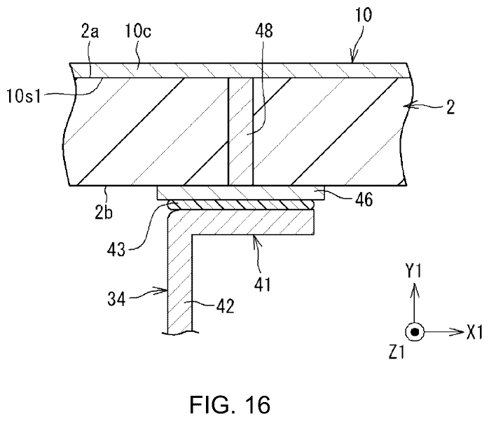

Note that the modification depicted in FIG. 15 can be applied to the eighth embodiment and also to the other modification to the eighth embodiment depicted in FIG. 16.

FIG. 16 is a cross-sectional view of a principal part of an antenna 1 according to another modification to the eighth embodiment.

In the eighth embodiment, a configuration where the second conductor portion 34 protrudes in the Y1 direction is depicted. In contrast, in this modification, a configuration where the second conductor portion 34 protrudes in the Y2 direction is depicted.

As depicted in FIG. 16, this modification includes a land portion 46 and a via 48. The land portion 46 is a conductor pattern and is provided on the second substrate surface 2b of the dielectric substrate 2. The via 48 passes through the dielectric substrate 2. The via 48 connects the intermediate portion 10c of the first conductor portion 10 and the land portion 46.

The base end conductor portion 41 of the second conductor portion 34 is fixed to the land portion 46 via an insulating adhesive layer 43.

Accordingly, the high-frequency signal applied to the feed point 8al is transmitted to the base end conductor portion 41 via the first conductor portion 10, the via 48, and the land portion 46, and then applied to the second conductor portion 34.

Modifications of Connection Between First Conductor Portion 10 and the Second Conductor Portion 34

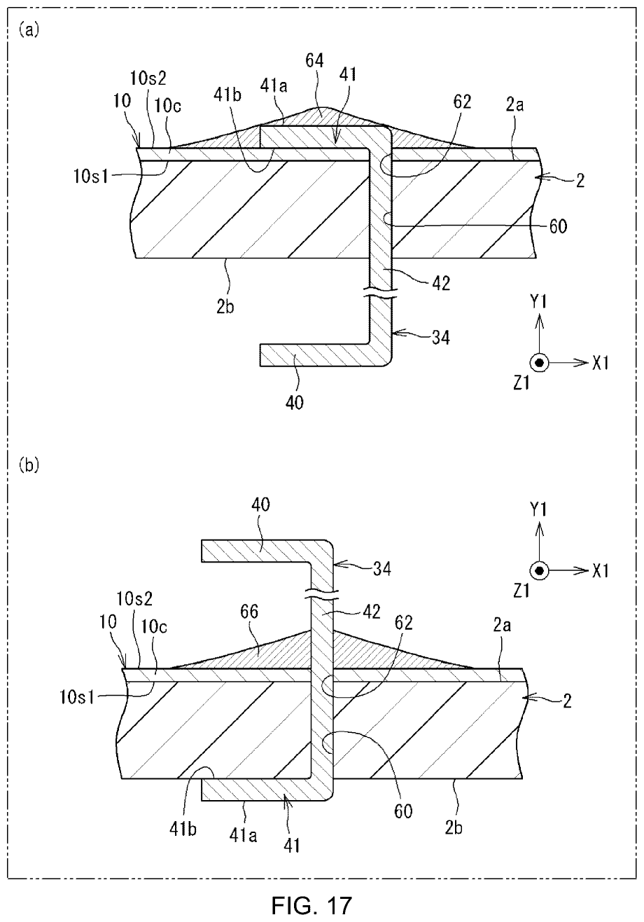

FIG. 17 is a diagram depicting modifications to the connection between the first conductor portion 10 and the second conductor portion 34.

The modification depicted in FIG. 17(a) differs from the eighth embodiment in that the second conductor portion 34 is inserted into a retaining hole 60 and a through hole 62.

The retaining hole 60 passes through the dielectric substrate 2 along the Y axis so as to connect the first substrate surface 2a and the second substrate surface 2b. The retaining hole 60 is a hole with a rectangular cross section corresponding to the cross-sectional shape of the second conductor portion 34. The inner surface of the retaining hole 60 and the outer surface of the second conductor portion 34 contact each other. By doing so, the retaining hole 60 holds the second conductor portion 34.

The through hole 62 passes through the intermediate portion 10c of the first conductor portion 10 so as to connect the first surface 10s1 and the second surface 10s2. The cross-sectional shape of the through hole 62 is substantially the same as the cross-sectional shape of the retaining hole 60. Also, an outline of the inner surface of the through hole 62 and an outline of the inner surface of the retaining hole 60 are substantially the same.

As described earlier, the second conductor portion 34 is inserted into the retaining hole 60 and the through hole 62. The main body portion 42 of the second conductor portion 14 passes through the retaining hole 60 and the through hole 62.

The plate-shaped conductor portion 40 and the base end conductor portion 41 in this modification extend in the X2 direction relative to the main body portion 42.

The base end conductor portion 41 protrudes from the second surface 10s2. The base end conductor portion 41 extends along the second surface 10s2 of the first conductor portion 10. The second surface 41b of the base end conductor portion 41 contacts the second surface 10s2 of the first conductor portion 10.

A fused portion 64 is provided on the second surface 10s2 of the first conductor portion 10. The fused portion 64 is formed of solder, for example. The fused portion 64 is formed so as to cover the outer surface of the base end conductor portion 41 that protrudes from the second surface 10s2 and the periphery of the base end conductor portion 41.

The first conductor portion 10 and the second conductor portion 34 are connected by this fused portion 64.

The second conductor portion 34 is held and fixed to the dielectric substrate 2 by the retaining hole 60 and the fused portion 64.

The second conductor portion 34 according to this modification is provided on the dielectric substrate 2 as described below.

First, a belt-like material that is the material of the second conductor portion 34 is inserted into the retaining hole 60 and the through hole 62.

Next, both ends of the belt-like material are bent to provide the plate-shaped conductor portion 40 and the base end conductor portion 41. At this time, the end portion on the base end conductor portion 41 side is caused to protrude from the second surface 10s2 of the first conductor portion 10 by the length required for the base end conductor portion 41, and the protruding portion is bent along the second surface 10s2. This bent portion becomes the base end conductor portion 41.

Next, the fused portion 64 is provided on the second surface 10s2 along which the base end conductor portion 41 has been provided.

By doing so, the second conductor portion 34 according to this modification is provided on the dielectric substrate 2.

The modification depicted in FIG. 17(b) differs from the eighth embodiment in that the second conductor portion 34 is inserted into the retaining hole 60 and the through hole 62 and in that the second conductor portion 34 protrudes from the first conductor portion 10 in the Y1 direction.

The base end conductor portion 41 according to the present embodiment protrudes from the second substrate surface 2b. The base end conductor portion 41 is disposed along the second substrate surface 2b of the dielectric substrate 2. The second surface 41b of the base end conductor portion 41 contacts the second substrate surface 2b.

A fused portion 66 in the present embodiment is formed so as to cover the outer surface of the main body portion 42 of the second conductor portion 34 that protrudes from the second surface 10s2 and the periphery of the main body portion 42.

This fused portion 66 connects the first conductor portion 10 and the second conductor portion 34.

The second conductor portion 34 is held and fixed to the dielectric substrate 2 by the retaining hole 60 and the fused portion 66.

The second conductor portion 34 according to this modification is provided on the dielectric substrate 2 as described below.

First, a belt-like material that is the material of the second conductor portion 34 is inserted into the retaining hole 60 and the through hole 62.

Next, both ends of the belt-like material are folded to provide the plate-shaped conductor portion 40 and the base end conductor portion 41. At this time, the base end conductor portion 41 side end is caused to protrude from the second substrate surface 2b by the length required for the base end conductor portion 41, and the protruding part is bent along the second substrate surface 2b. This bent part becomes the base end conductor portion 41.

Next, the fused portion 66 is provided on the second surface 10s2 from which the main body portion 42 protrudes.

By doing so, the second conductor portion 34 according to this modification is provided on the dielectric substrate 2.

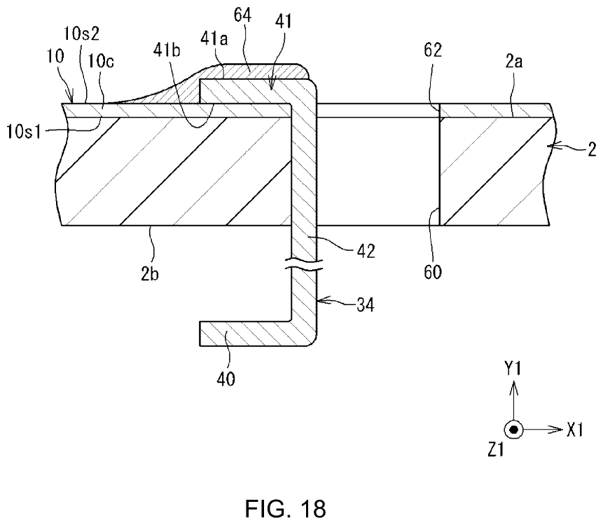

FIG. 18 is a diagram depicting another modification to the connection between the first conductor portion 10 and the second conductor portion 34.

The modification depicted in FIG. 18 differs from the modification depicted in FIG. 17 in that the dimensions of the retaining hole 60 and the through hole 62 along the X axis are increased.

In this modification, the dimensions along the X axis of the retaining hole 60 and the through hole 62 are greater than at least one of the dimension along the X axis of the plate-shaped conductor portion 40 and the dimension along the X axis of the base end conductor portion 41.

Accordingly, with this modification, both ends of the belt-like material that is the material of the second conductor portion 34 are bent to provide the plate-shaped conductor portion 40 and the base end conductor portion 41, and the part formed as the second conductor portion 34 can be inserted into the retaining hole 60 and the through hole 62.

As depicted in FIG. 18, the base end conductor portion 41 of the second conductor portion 34 inserted into the retaining hole 60 and the through hole 62 protrudes from the second surface 10s2 and extends along the second surface 10s2 of the first conductor portion 10. The second surface 41b of the base end conductor portion 41 contacts the second surface 10s2 of the first conductor portion 10.

The fused portion 66 is formed so as to cover the outer surface of the main body portion 42 of the second conductor portion 34 that protrudes from the second surface 10s2 and the periphery of the main body portion 42.

By doing so, the first conductor portion 10 and the second conductor portion 34 are connected.

The second conductor portion 34 is also held and fixed to the dielectric substrate 2 by the retaining hole 60 and the fused portion 64.

Although FIG. 18 depicts a case where the second conductor portion 34 protrudes from the first conductor portion 10 in the Y2 direction, by placing the plate-shaped conductor portion 40 in FIG. 18 in contact with the second substrate surface 2b to separate the base end conductor portion 41 in FIG. 18 from the first conductor portion 10, it is possible to make the second conductor portion 34 protrude from the first conductor portion 10 in the Y1 direction.

In this configuration, the base end conductor portion 41 in FIG. 18 functions as a plate-shaped conductor portion and the plate-shaped conductor portion 40 in FIG. 18 functions as a base end conductor portion.

When the base end conductor portion 41 in FIG. 18 functions as a plate-shaped conductor portion and the plate-shaped conductor portion 40 in FIG. 18 functions as a base end conductor portion, the fused portion 64 is formed to cover the outer surface of the main body portion 42 of the second conductor portion 34 that protrudes from the second surface 10s2 and the periphery of the main body portion 42.

With this modification, since the second conductor portion 34 with the plate-shaped conductor portion 40 and the base end conductor portion 41 can be inserted into the retaining hole 60 and the through hole 62, the second conductor portion 34 can be easily provided on the dielectric substrate 2.

Also, since it is possible to use a second conductor portion 34, a dielectric substrate 2, and the like with the same configuration and select the protruding direction out of the Y1 direction and the Y2 direction, it is possible to reduce cost.

### Other Modifications

Although examples where a solid linear member made of a conductor is used as the second conductor portion 14 (the main body portion 22) have been described in the first to seventh embodiments given above, the second conductor portion 14 can also be made of a hollow rod-shaped member and a conductive film provided on the surface of this member and connected to the first conductor portion 10.

Although examples have been described where the plate-shaped conductor portions 20 according to the second and fourth embodiments and the plate-shaped conductor portion 40 according to the eighth embodiment are circular in shape, such members may be non-circular shapes, such as polygonal shapes. However, from the viewpoint of uniformly exciting electromagnetic field components around the plate-shaped conductor portions 20 and 40, it is preferable for the plate-shaped conductor portions 20 and 40 to be formed in a circular shape.

Note that examples where the plate-shaped conductor portion 20 (40) is fixed in a state where the plate-shaped conductor portion abuts the other end 22b (42b) of the main body portion 22 (42) have been described in the second, fourth and eighth embodiments.

However, when the plate-shaped conductor portion 20 (40) includes a hole, the plate-shaped conductor portion 20 (40) may be fixed to the other end 22b (42b) in a state where the other end 22b (42b) is inserted into this hole.

In this case, the other end 22b (42b) may pass through the plate-shaped conductor portion 20 (40). By doing so, the plate-shaped conductor portion 20 (40) can be moved along the main body portion 22 (42) so that the attachment position of the plate-shaped conductor portion 20 (40) can be adjusted in the length direction of the main body portion 22 (42).

The embodiments described above can be combined as appropriate.

As one example, in a configuration where the antenna 1 includes a second conductor portion 14 that protrudes in the Y1 direction from the first conductor portion 10 as in the sixth embodiment, the second conductor portion 14 may include the plate-shaped conductor portion 20.

In the seventh embodiment, a configuration where the second conductor portion 14 with a spiral shape protrudes from the first conductor portion 10 in the Y1 direction is described. However, a second conductor portion 14 with a spiral shape may protrude from the first conductor portion 10 in the Y2 direction.

Also, although an example configuration where the second conductor portion 34, which is constructed made of a rectangular plate-shaped member, is provided on the first conductor portion 10 that constructs an inverted-F antenna element has been described in the eighth embodiment, a second conductor portion 34 constructed of a rectangular plate-shaped member may also be provided on a first conductor portion 10 with a meander line structure.

In addition, combinations that can be applied to a first conductor portion 10 that constructs an inverted-F antenna element in the respective embodiments can also be applied to a first conductor portion 10 that constructs the inverted-L antenna element described in the fifth embodiment.

In each of the above embodiments, configurations where the second ground conductor portion 6 is provided on the second substrate surface 2b have been described. However, it is also possible to use a configuration where no second ground conductor portion 6 is provided on the second substrate surface 2b.

In that case, the plurality of vias 19 that connect the second ground conductor portion 6 and the first ground conductor portion 4 are unnecessary.

In each of the embodiments described above, configurations where the second conductor portions 14 and 34 protrude from the intermediate portion 10c in a direction that is perpendicular to the substrate surfaces 2a and 2b have been described. However, it is sufficient for the second conductor portions 14 and 34 to protrude from the intermediate portion 10c and the second conductor portions may protrude in directions that merely intersect the substrate surfaces 2a and 2b.

Although configurations where a cylindrical second conductor portion 14 is inserted into the retaining hole 30 are described in the first and sixth embodiments, a belt-like second conductor portion 14 may be inserted into a retaining hole. In this case, the retaining hole is rectangular in shape to conform to the shape of the second conductor portion 14.

### Verification Test 1

Verification Test 1, which was conducted to investigate the effects of the antenna 1, is described below.

The test method includes constructing a model of the antenna 1 and using the model to obtain the directional characteristics of the antenna 1 through computer simulation. The frequency of the high-frequency signal used to test the antenna 1 was set at 2.45 GHz.

In Verification Test 1, the following four specific examples and two comparative examples were used as test subjects, the radiation patterns of vertically polarized wave components and horizontally polarized wave components were obtained, and the obtained patterns were compared to verify the effect of the antenna 1.

Note that the respective thicknesses of the first ground conductor portion 4, the second ground conductor portion 6, the feed conductor portion 8, the first conductor portion 10, and the short-circuit conductor portion 12 were set at 36 μm.

### Specific Example 1

The antenna 1 described in the first embodiment was constructed as a model used as Specific Example 1.

In other words, in Specific Example 1, an antenna 1 with a second conductor portion 14 that does not include a plate-shaped conductor portion 20 was tested.

The dimensions of the respective parts of the first conductor portion 10 and the second conductor portion 14 were set as follows.
Length L1: 27 mm
Distance L2: 11 mm
Width of first conductor portion 10 along the Z axis: 3 mm
Width of short-circuit conductor portion 12 along the X axis: 4 mm
Width from Z1 direction edge of first conductor portion 10 to edge portion 4a of first ground conductor portion 4: 8 mm
Diameter of second conductor portion 14: 0.3 mm
Length H of second conductor portion 14: 30 mm

### Specific Example 2

The antenna 1 described in the second embodiment was constructed as a model used as Specific Example 2.

In other words, in Specific Example 2, an antenna 1 with a second conductor portion 14 that includes a plate-shaped conductor portion 20 was tested.

The length H of the second conductor portion 14 was set at 20 mm.

The diameter D of the plate-shaped conductor portion 20 was set at 10 mm.

The model of Specific Example 2 was set the same as the model of Specific Example 1, except that the second conductor portion 14 includes a plate-shaped conductor portion 20 and the length H is 20 mm.

### Specific Example 3

The antenna 1 described in the third embodiment that has a meander line structure was constructed as a model used as Specific Example 3.

In other words, in Specific Example 3, an antenna 1 with a second conductor portion 14 that does not include a plate-shaped conductor portion 20 was tested.

The dimensions of the respective parts of the first conductor portion 10 and the second conductor portion 14 were set as follows.
Total length of first conductor portion 10: 186.5 mm
   Distance L4: 3.25 mm
   Distance L5: 1.0 mm
   Distance L6: 10 mm
   Distance L7: 0.75 mm
   Width along X axis of first line 26: 0.5 mm
   Width along Z axis of second line 28: 0.5 mm
   Diameter of second conductor portion 14: 0.3 mm
   Length H of second conductor portion 14: 30 mm

### Specific Example 4

The antenna 1 described in the fourth embodiment that includes a meander line structure was constructed as a model used as Specific Example 4.

In other words, in Specific Example 4, an antenna 1 with a second conductor portion 14 that includes a plate-shaped conductor portion 20 was tested.

The length H of the second conductor portion 14 was set at 20 mm.

The diameter D of the plate-shaped conductor portion 20 was set at 10 mm.

The model of Specific Example 4 was set the same as the model of Specific Example 3, except that the second conductor portion 14 includes a plate-shaped conductor portion 20 and the length H is 20 mm.

### Comparative Example 1

A model used as Comparative Example 1 was constructed by omitting the second conductor portion 14 from the antenna 1 described in the first embodiment.

### Comparative Example 2

A model used as Comparative Example 2 was constructed by removing the second conductor portion 14 from the antenna 1 described in the third embodiment.

Comparison between Specific Example 1 and Comparative Example 1

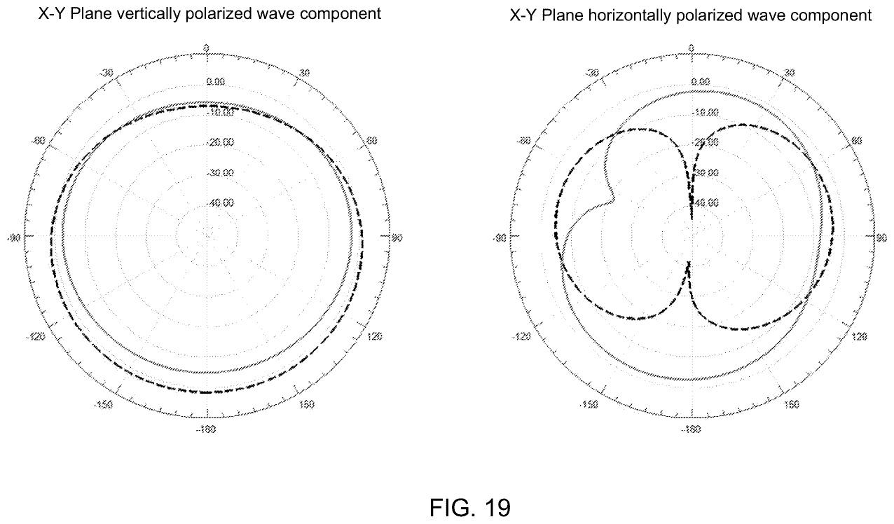

FIG. 19 is a diagram depicting radiation patterns of vertically polarized wave components and horizontally polarized wave components for Specific Example 1 and Comparative Example 1 on the X-Y plane.

In FIG. 19, solid lines indicate the radiation patterns for Specific Example 1. The dashed lines indicate the radiation patterns for Comparative Example 1.

In FIG. 19, “0” indicates the X1 direction, and “90” indicates the Y1 direction.

As depicted in FIG. 19, for the vertically polarized wave components on the X-Y plane, no significant difference is observed between Specific Example 1 and Comparative Example 1. In addition, no drop in gain is observed for either Specific Example 1 or Comparative Example 1.

On the other hand, partial drops in gain along the X axis are observed for horizontally polarized wave components for Comparative Example 1.

In contrast, it can be understood that such partial drops in gain that are observed for Comparative Example 1 are suppressed with Specific Example 1.

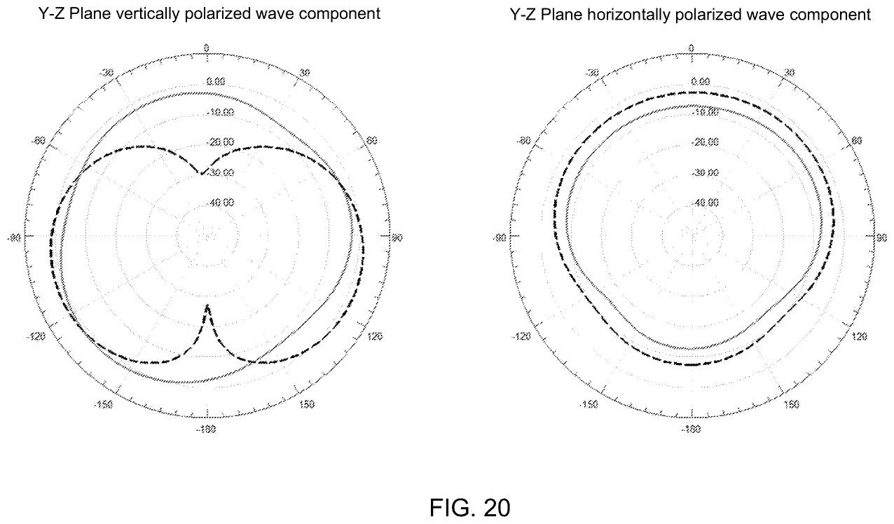

FIG. 20 is a diagram depicting radiation patterns of vertically polarized wave components and horizontally polarized wave components for Specific Example 1 and Comparative Example 1 on the Y-Z plane.

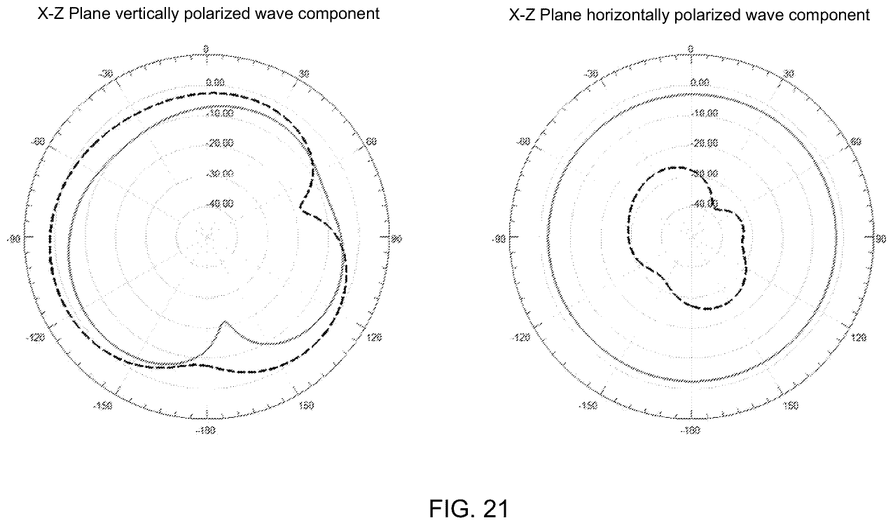

FIG. 21 is a diagram depicting radiation patterns of vertically polarized wave components and horizontally polarized wave components for Specific Example 1 and Comparative Example 1 on the X-Z plane.

In FIGS. 20 and 21, solid lines indicate radiation patterns for Specific Example 1. Dashed lines indicate radiation patterns for Comparative Example 1.

In FIG. 20, “0” indicates the Z1 direction, and “90” indicates the Y1 direction. In FIG. 21, “0” indicates the Z1 direction, and “90” indicates the X1 direction.

As depicted in FIG. 20, for the horizontally polarized wave components on the Y-Z plane, no significant difference is observed between Specific Example 1 and Comparative Example 1. In addition, no drop in gain is observed for either Specific Example 1 or Comparative Example 1.

On the other hand, partial drops in gain along the Z axis are observed for vertically polarized wave components for Comparative Example 1.

In contrast, it can be understood that such partial drops in gain that are observed for Comparative Example 1 are suppressed with Specific Example 1.

As depicted in FIG. 21, for the vertically polarized wave components on the Y-Z plane, no significant difference is observed between Specific Example 1 and Comparative Example 1. In addition, no large drop in gain is observed for either Specific Example 1 or Comparative Example 1.

On the other hand, the gain appears to be extremely low in all directions for horizontally polarized wave components for Comparative Example 1.

In contrast, it can be understood that this drop in gain in all directions that is observed for Comparative Example 1 is suppressed with Specific Example 1.

Comparison between Specific Example 2 and Comparative Example 1

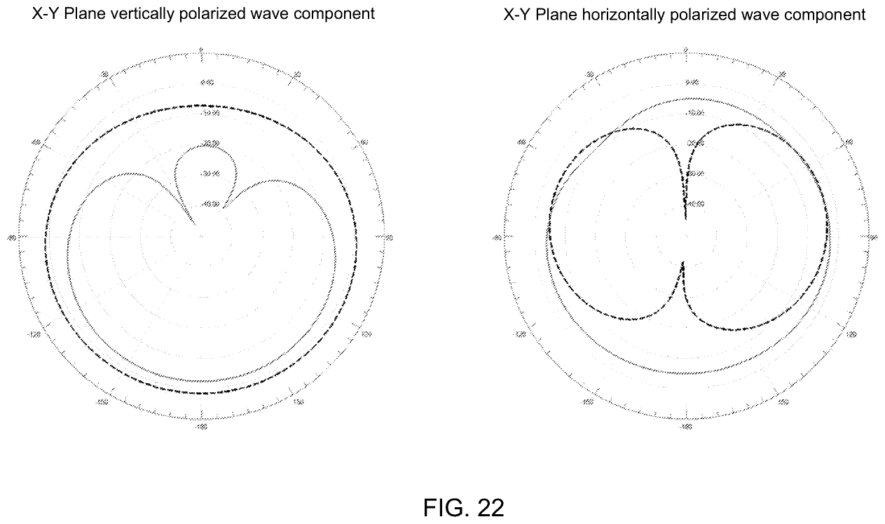

FIG. 22 is a diagram depicting radiation patterns of vertically polarized wave components and horizontally polarized wave components for Specific Example 2 and Comparative Example 1 on the X-Y plane.

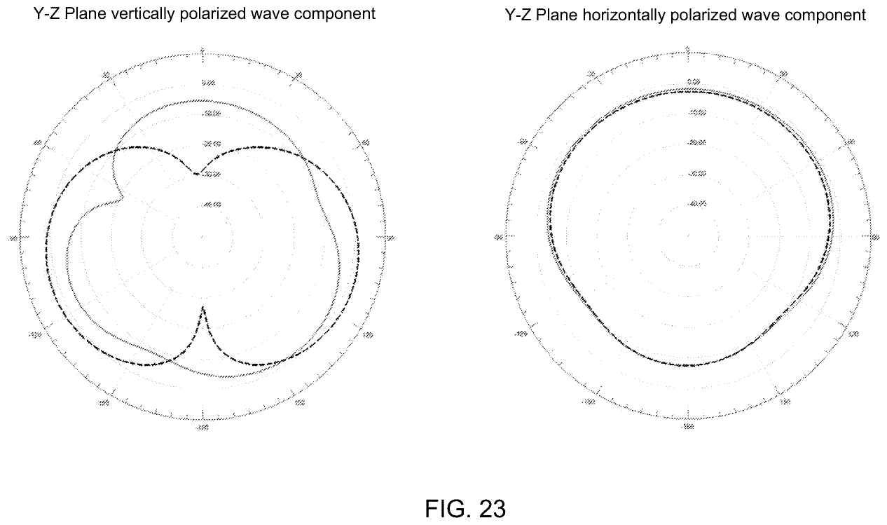

FIG. 23 is a diagram depicting radiation patterns of vertically polarized wave components and horizontally polarized wave components for Specific Example 2 and Comparative Example 1 on the Y-Z plane.

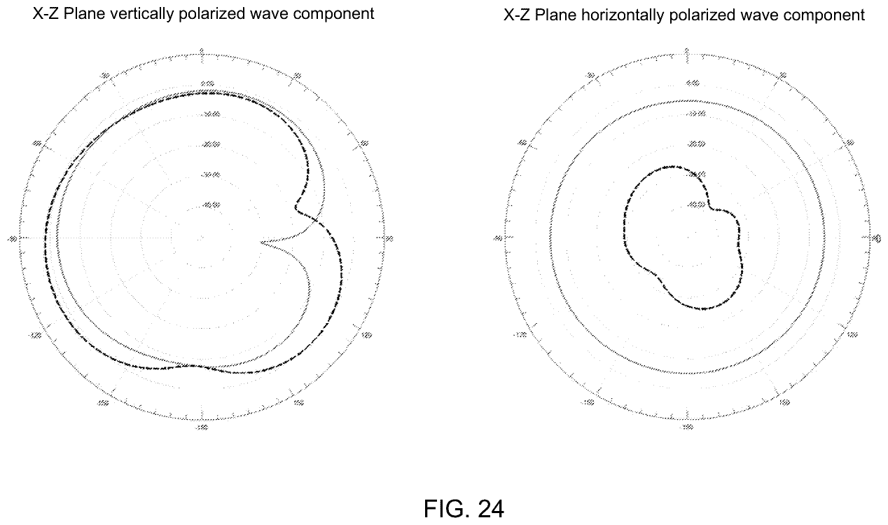

FIG. 24 is a diagram depicting radiation patterns of vertically polarized wave components and horizontally polarized wave components for Specific Example 2 and Comparative Example 1 on the X-Z plane.

The method of illustration used in FIGS. 22 to 24 is the same as the method used in FIGS. 19 to 21.

Like Specific Example 1, it can be understood that with Specific Example 2, the partial drops in gain that are observed for horizontally polarized wave components on the X-Y plane and vertically polarized wave components on the Y-Z plane are suppressed.

With Specific Example 2, the drop in gain in all directions that is observed for horizontally polarized wave components on the X-Z plane is also suppressed.

Comparison between Specific Example 3 and Comparative Example 2

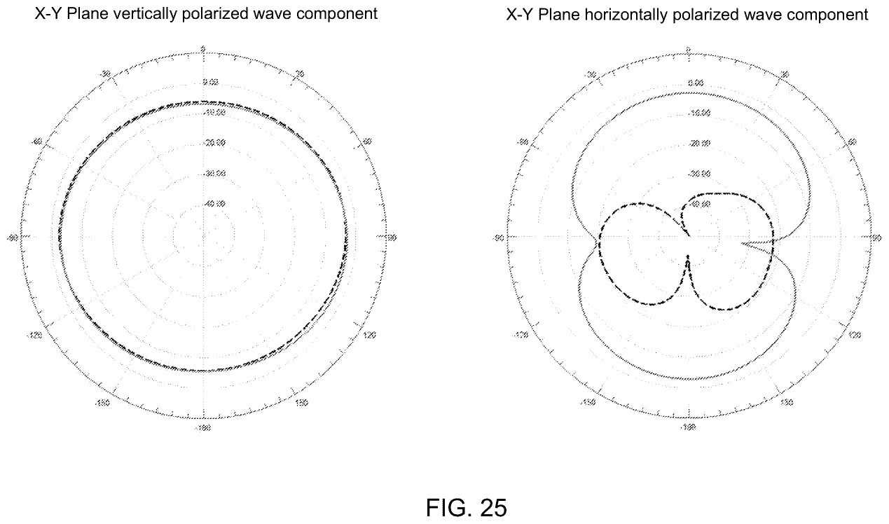

FIG. 25 is a diagram depicting radiation patterns of vertically polarized wave components and horizontally polarized wave components for Specific Example 3 and Comparative Example 2 on the X-Y plane.

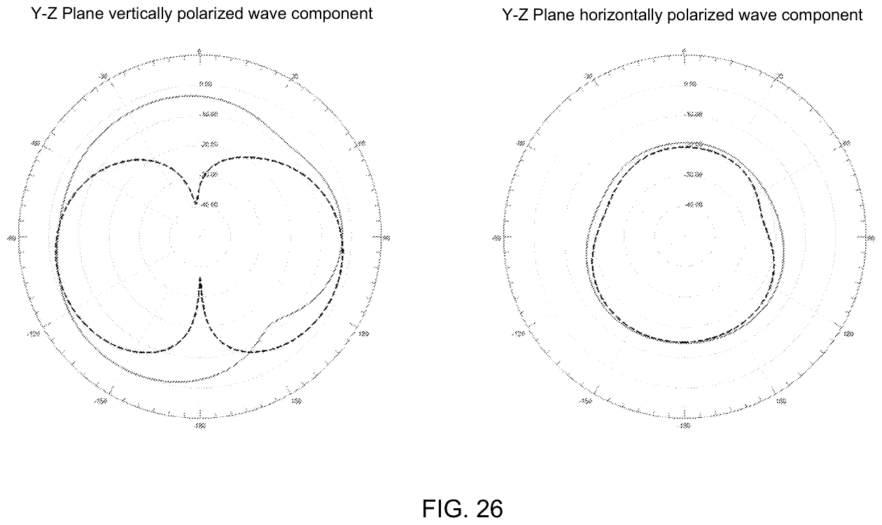

FIG. 26 is a diagram depicting radiation patterns of vertically polarized wave components and horizontally polarized wave components for Specific Example 3 and Comparative Example 2 on the Y-Z plane.

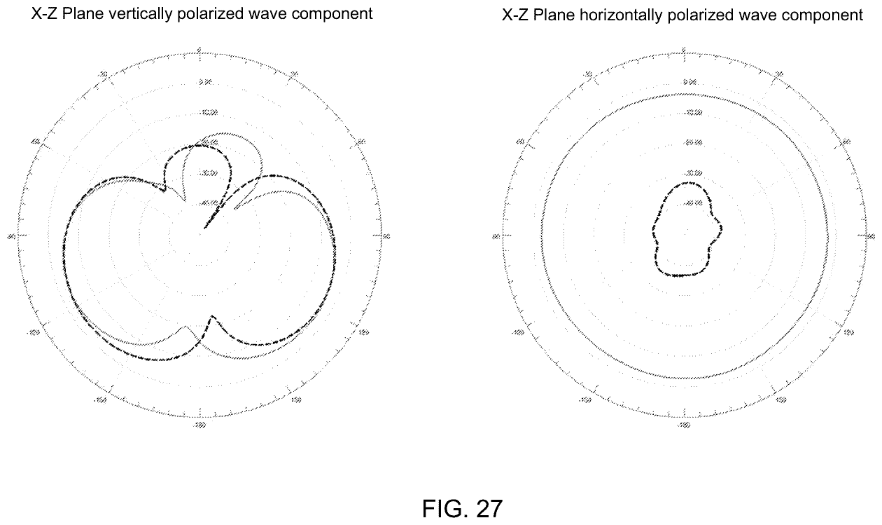

FIG. 27 is a diagram depicting radiation patterns of vertically polarized wave components and horizontally polarized wave components for Specific Example 3 and Comparative Example 2 on the X-Z plane.

The method of illustration used in FIGS. 25 to 27 is the same as the method used in FIGS. 19 to 21.

It can be understood that with Specific Example 3 also, the partial drops in gain that are observed for horizontally polarized wave components on the X-Y plane and vertically polarized wave components on the Y-Z plane, as well as the drop in gain in all directions that is observed for horizontally polarized wave components on the X-Z plane, are suppressed.

Comparison between Specific Example 4 and Comparative Example 2

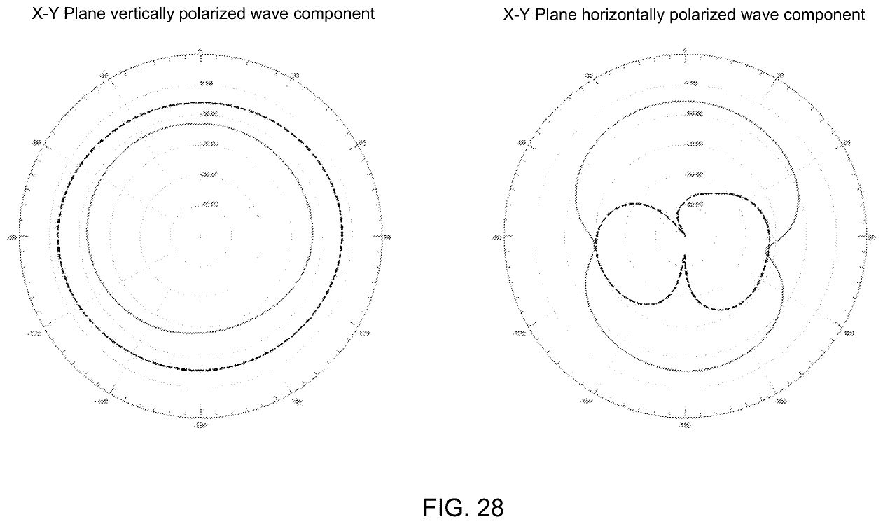

FIG. 28 is a diagram depicting radiation patterns of vertically polarized wave components and horizontally polarized wave components for Specific Example 4 and Comparative Example 2 on the X-Y plane.

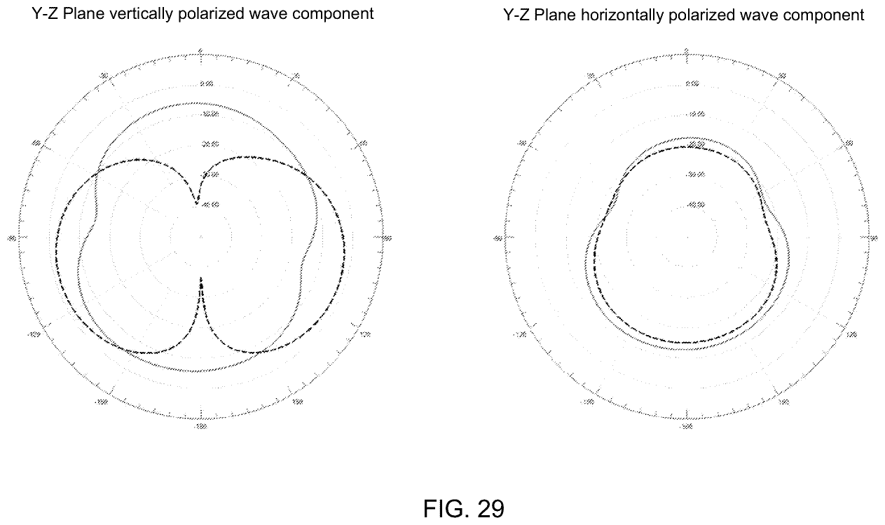

FIG. 29 is a diagram depicting radiation patterns of vertically polarized wave components and horizontally polarized wave components for Specific Example 4 and Comparative Example 2 on the Y-Z plane.

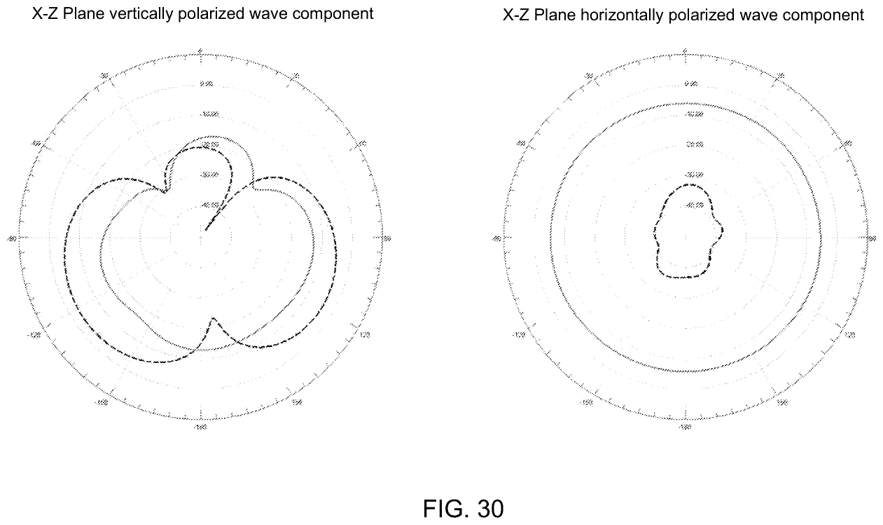

FIG. 30 is a diagram depicting radiation patterns of vertically polarized wave components and horizontally polarized wave components for Specific Example 4 and Comparative Example 2 on the X-Z plane.

The method of illustration used in FIGS. 28 to 30 is the same as the method used in FIGS. 19 to 21.

It can be understood that with Specific Example 4 also, the partial drops in gain that are observed for horizontally polarized wave components on the X-Y plane and vertically polarized wave components on the Y-Z plane, as well as the drop in gain in all directions that is observed for horizontally polarized wave components on the X-Z plane, are suppressed.

From the above results, it can be understood that it is possible to suppress the drop in gain of polarized wave components that are perpendicular to the substrate surface.

In more detail, it can be confirmed that it is possible to suppress the partial drop in gain observed for horizontally polarized wave components on the X-Y plane and vertically polarized wave components on the Y-Z plane, as well as the drop in gain for horizontally polarized wave components on the X-Z plane.

### Verification Test 2

Verification Test 2, which was conducted to evaluate the length H of the second conductor portion 14 of the antenna 1, is described below.

The test method includes setting a plurality of values of the length H of the second conductor portion 14, obtaining polarization characteristics for each of the plurality of set values, and evaluating the relationship between the length H of the second conductor portion 14 and the polarization characteristics.

Note that in Verification Test 2, the difference in gain Δ (which is minimum value-maximum value) between the minimum and maximum values of the gain in the polarization characteristics on each of the X-Y plane and the Y-Z plane was obtained, and the relationship between the difference in gain Δ and the length H was found.

Note that this difference in gain Δ indicates the extent of the partial drop in gain in the polarization characteristics. It can be said that the closer the difference in gain Δ to 0, the smaller the partial drop.

Verification Test 2 was conducted on Specific Examples 5, 6, and 7 indicated below.

### Specific Example 5

The model was set the same as Specific Example 1, except that the length H of the second conductor portion 14 was changed within the range of 0 to 120 mm.

In Specific Example 5, an antenna 1 with a second conductor portion 14 that does not include a plate-shaped conductor portion 20 was tested.

### Specific Example 6

The model was set the same as Specific Example 2, except that the length H of the second conductor portion 14 was changed within the range of 0 to 120 mm and the diameter D of the plate-shaped conductor portion 20 was set at 6 mm.

In Specific Example 6, an antenna 1 with a second conductor portion 14 that includes a plate-shaped conductor portion 20 was tested.

### Specific Example 7

The model was set the same as Specific Example 2, except that the length H of the second conductor portion 14 was changed within the range of 0 to 120 mm.

In Specific Example 7, an antenna 1 with a second conductor portion 14 that includes a plate-shaped conductor portion 20 with a larger diameter than in Specific Example 6 was tested.

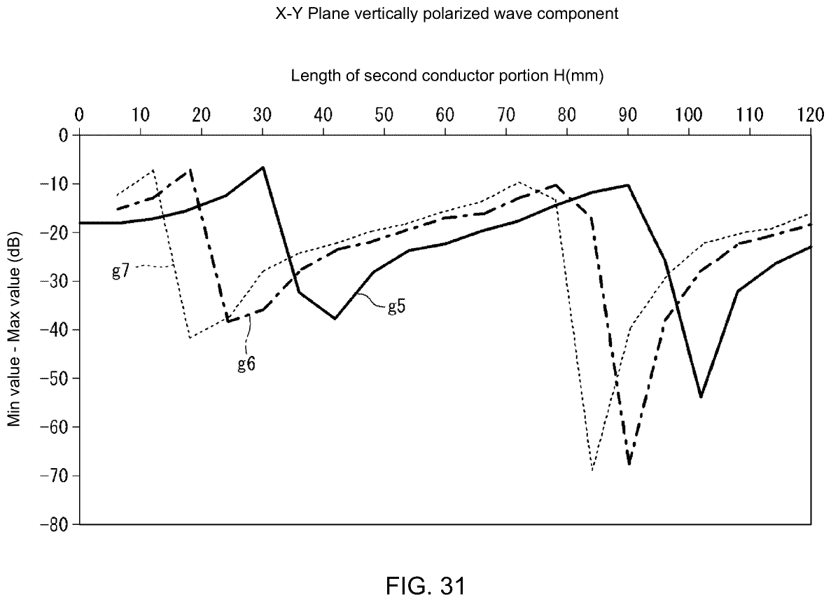

FIG. 31 is a diagram depicting the relationship between the difference in gain Δ for vertically polarized wave components on the X-Y plane and the length H of the second conductor portion 14.

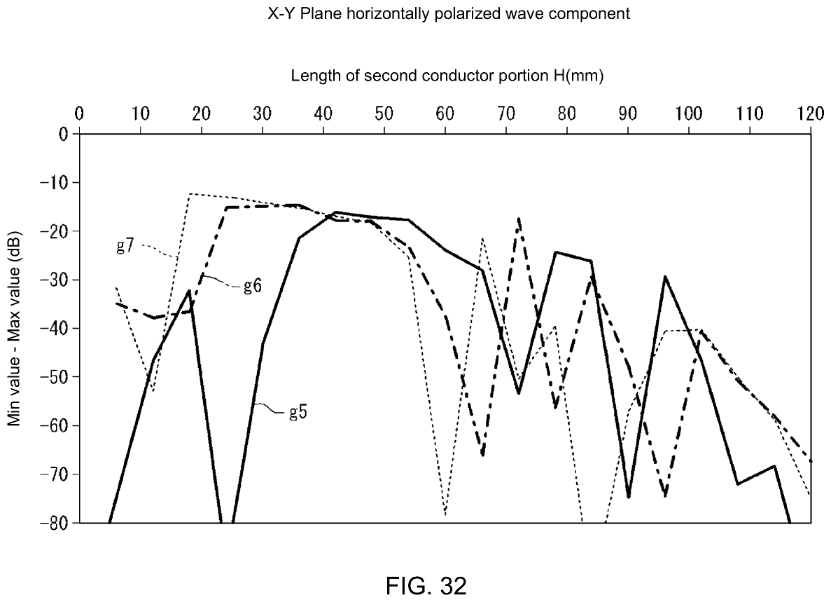

FIG. 32 is a diagram depicting the relationship between the difference in gain Δ for horizontally polarized wave components on the X-Y plane and the length H of the second conductor portion 14.

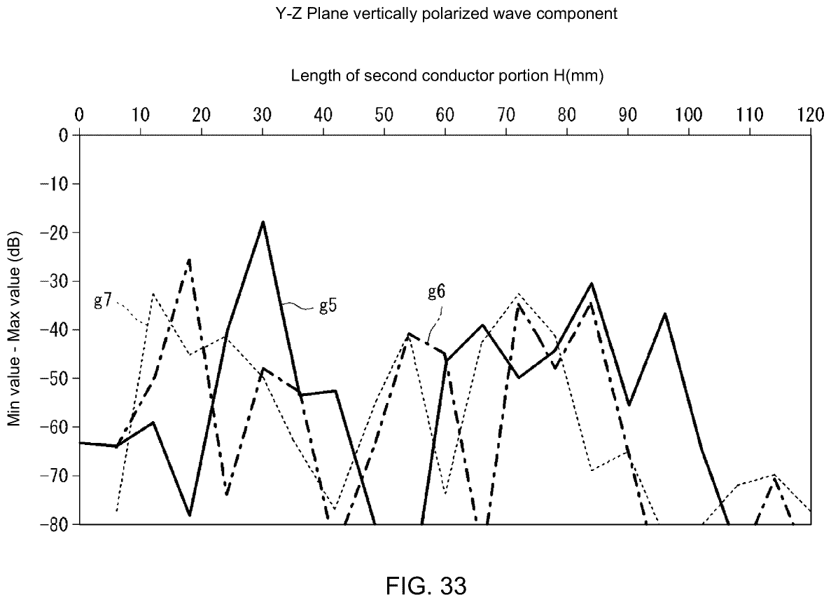

FIG. 33 is a diagram depicting the relationship between the difference in gain Δ for vertically polarized wave components on the Y-Z plane and the length H of the second conductor portion 14.

In FIGS. 31 to 33, the vertical axis represents the difference in gain Δ for polarized wave components and the horizontal axis represents the length H of the second conductor portion 14.

In FIGS. 31 to 33, a line g5 indicates the difference in gain Δ for Specific Example 5. A line g6 indicates the difference in gain Δ for Specific Example 6. A line g7 indicates the difference in gain Δ for Specific Example 7.

From the line g5 in FIG. 31, it can be understood that in a range of length H from 0 mm to 30 mm, the difference in gain Δ gradually approaches 0 as the length H increases.

From the line g6 in FIG. 31, it can be understood that in a range of length H from 0 mm to 30 mm, the difference in gain Δ becomes closest to 0 when the length H is approximately 18 mm.

From the line g7 in FIG. 31, in the range of length H from 0 mm to 30 mm, the difference in gain Δ is closest to 0 when the length H is 12 mm.

The difference in gain Δ when the lines g5, g6, and g7 are closest to 0 is around −10 dB.

From these results, it can be understood that the length H of the second conductor portion 14 in Specific Examples 6 and 7 at which the difference in gain Δ becomes closest to zero is smaller than the length H of the second conductor portion 14 in Specific Example 5 at which the difference in gain Δ becomes closest to zero. In other words, the length H at which partial drops in the vertically polarized wave characteristics can be effectively suppressed is reduced by providing the plate-shaped conductor portion 20 on the second conductor portion 14.

Similar results are also obtained in FIGS. 32 and 33.

From these results, it can be understood that by including the plate-shaped conductor portion 20 in the second conductor portion 14, the length H of the second conductor portion 14 can be made shorter than the length H of a second conductor portion 14 that does not include a plate-shaped conductor portion 20.

Also from the above results, it can be understood that the length H at which partial drops in the vertically polarized wave characteristics can be effectively suppressed can be made shorter by increasing the diameter D of the plate-shaped conductor portion 20. From this result, it can be understood that by making the diameter D of the plate-shaped conductor portion 20 of the second conductor portion 14 larger, the length H of the second conductor portion 14 can be reduced.

As can be understood from FIGS. 31 to 33, when the length H of the second conductor portion 14 is smaller than 10 mm, the difference in gain Δ tends to significantly deviate from 0. When the length H of the second conductor portion 14 is larger than 30 mm, the difference in gain Δ tends to vary significantly.

When the length H of the second conductor portion 14 is 10 mm, the ratio of the length H to the dimension in the length direction (that is, the length L1) of the first conductor portion 10 is 0.37, and when the length H of the second conductor portion 14 is 30 mm, the ratio of the length H to the dimension in the length direction (that is, the length L1) of the first conductor portion 10 is 1.1.

In other words, from FIGS. 31 to 33, it can be understood that when the ratio of the dimension in the length direction (that is, the length H) of the second conductor portion 14 to the dimension in the length direction (that is, the length L1) of the first conductor portion 10 is in a range of 0.36 or higher and 1.2 or lower, a drop in gain of polarized wave components perpendicular to the substrate surfaces can be effectively suppressed.

### OTHER CONSIDERATIONS

All features of the embodiments disclosed here are exemplary and should not be regarded as limitations on the present disclosure.

The scope of the present disclosure is indicated by the patent claims, not the description given above, and is intended to include all changes within the meaning and scope of the wording of the claims and their equivalents.

1. An antenna comprising:
a dielectric substrate;
a feed conductor portion provided on the dielectric substrate;
a first conductor portion that is provided on a substrate surface of the dielectric substrate, is connected to the feed conductor portion, and is linear or belt-like with one end as an open end; and
a second conductor portion that is linear or belt-like and includes a first end portion and a second end portion on an opposite side to the first end portion,
wherein the first end portion is connected to an intermediate portion between both ends of the first conductor portion,
the second end portion is an open end, and
the second conductor portion protrudes from the intermediate portion.

2. The antenna according to claim 1, wherein the dielectric substrate includes a retaining hole into which the first end portion is inserted.

3. The antenna according to claim 2, wherein the intermediate portion includes a through hole into which the first end portion is inserted.

4. The antenna according to claim 1, wherein the first end portion includes a plate-shaped base end conductor portion that extends along the intermediate portion.

5. The antenna according to claim 4, further comprising an insulating adhesive layer provided between the base end conductor portion and the intermediate portion.

6. The antenna according to claim 1,
wherein the second end portion includes a plate-shaped conductor portion along an intersecting plane that intersects a length direction of the second conductor portion.

7. The antenna according to claim 1, wherein a ratio of a dimension in a length direction of the second conductor portion to a dimension in a length direction of the first conductor portion is 0.36 or greater and 1.2 or lower.

8. The antenna according to claim 1, wherein the first conductor portion constructs an inverted-F antenna.

9. The antenna according to claim 1, wherein the first conductor portion constructs an inverted-L antenna element.

10. The antenna according to claim 1, wherein the first conductor portion constructs a meander line structure.
